(19) United States
(12) Patent Application Publication
(10) Pub. No.: US 2026/0264311 A1
(43) Pub. Date: Sep. 10, 2026

(54) RIGID MEDICAL PACKAGING MADE FROM CRYSTALLINE OR SEMI-CRYSTALLINE THERMOPLASTIC POLYMERS SUITALBE FOR AUTOCLAVE STEAM STERILIZATION

(71) Applicant: Ryan Neill, Rogersville, TN (US)

(72) Inventor: Ryan Neill, Rogersville, TN (US)

(21) Appl. No.: 19/160,730

(22) PCT Filed: May 31, 2024
(86) PCT No.: PCT/US2024/032059

§ 371 Date: Aug. 28, 2025

Related U.S. Application Data
(60) Provisional application No. 63/470,340, filed on Jun. 1, 2023.
(60) Provisional application No. 63/470,352, filed on Jun. 1, 2023.
(60) Provisional application No. 63/538,683, filed on Sep. 15, 2023.

(51) Int. Cl. B29C 51/10; B29C 51/04; B29C 51/08; B29C 51/26; B29C 51/46; B29C 55/12; B29L 31/00

(52) U.S. Cl. CPC B29C 51/10; B29C 51/04; B29C 51/082; B29C 51/263; B29C 51/46; B29C 55/12; B29C 2791/001; B29C 2791/005; B29K 2995/0017; B29K 2995/004; B29K 2995/0041; B29L 2031/712; B29L 2031/753

(57) ABSTRACT

The present disclosure describes a multi-step, novel process for altering the morphological polymer architecture of crystalline or semi-crystalline film or sheet such that articles or packages made from said film remain initially thermoformable yet can withstand steam sterilization without a significant degree of shrinkage, warpage, or generation of visual haze.

### CROSS-REFERENCE TO RELATED APPLICATION

This application claims the benefit of U.S. Provisional Application 63/470,340 filed Jun. 1, 2023, U.S. Provisional Application 63/470,352 filed Jun. 1, 2023, and U.S. Provisional Application 63/538,683 filed Sep. 15, 2023, all of which are hereby incorporated by reference.

### BACKGROUND OF THE INVENTION

Today, clear, rigid medical packaging is normally made from non-oriented PETG copolyester, or alternatively, from the less expensive, non-oriented polyesters PET/APET. Three-dimensional packages made from either of these materials can be sterilized by ethylene oxide, gamma radiation, or other processes, but neither packaging material can be properly steam sterilized or heat treated without detrimentally altering the package, due to the materials' relatively low heat distortion temperature. A second issue with both of these traditional materials is that they can also undergo warpage and a significant amount of physical aging, leading to embrittlement and the potential for a loss in package sterility when the (ethylene oxide, gamma, etc.) sterilization protocol is severe or when multiple sterilization cycles are necessary.

For example, rigid medical packaging currently available made from amorphous film of PETG, PET, or APET cannot be steam sterilized because the glass transition temperature and heat distortion temperature of these materials are approximately 77 to 82 degrees Celsius whereas steam sterilization at pressures greater than about 14.7 pounds per square inch (one atmosphere at sea level) must occur at 100 degrees Celsius and more often at 121 degrees Celsius. When packaging made from these amorphous substrates is steam sterilized, the packaging detrimentally warps, sags, distorts and, for PET and APET, the packages crystallize and significantly generate haze, often turning opaque white with significant embrittlement. The traditional methods for making rigid medical packaging using these traditional materials are not suitable for steam sterilization.

In contrast, rigid medical packaging made from amorphous film of polycarbonate and similar substrates with a glass transition temperature of approximately 150 degrees Celsius survive steam sterilization but have several undesirable features such as the potential presence of BPA (bisphenol A), a chemical monomer that generally is avoided in some applications, such as those related to food and medicine. Further, when rigid medical packaging is thermoformed from polycarbonate film, the film often must undergo the additional processing step of drying the sheet before thermoforming to remove moisture from the film or bubbles can develop in the package which are unsightly and can lead to concerns of a sterility breach. This phenomenon is common with sheets made from many hygroscopic, clear resins with glass transition temperatures above approximately 130 degrees Celsius. These negative attributes lead some packaging design experts to seek other packaging solutions made from other substrates that can be steam sterilized.

### SUMMARY OF THE INVENTION

The present disclosure identifies the chemical architecture (e.g., polymeric morphology), processing techniques, and operational ranges needed to induce a certain degree of orientation into the semi-crystalline resin used in articles, such as medical packaging, while maintaining the ability of the resin in sheet form to be thermoformed into three-dimensional articles. Coupled with the subsequent heat setting step (preferably after the stretching and forming), three-dimensional articles can be subsequently steam sterilized in an autoclave without a significant degree of haze generation or package warpage. Articles or packages made from the processes described in the current disclosure have the additional advantage of also being tougher, among other physical property improvements, than packages made from amorphous PETG, PET or APET and utilize chemistries that are traditionally less expensive than PETG.

The present disclosure involves starting with a crystalline or semi-crystalline thermoplastic polymer and forming this resin into a clear film or sheet through traditional processing such as extrusion. The clear film or sheet is then partially stretched or oriented in a process such as occurs on a tenter frame. This partially stretched film or sheet is then heated and thermoformed into a three-dimensional article. The three-dimensional article, optionally packaging, optionally rigid medical packaging, is then heated while on the mold to heat set or remove internal part stresses (thermoplastic “memory”) from the three-dimensional article so that it is dimensionally stable up to the heat set temperature. The three-dimensional article is then closed around a device, optionally a medical device, sealed and steam sterilized for sanitized use.

For example, in some embodiments, PET or APET film or sheet can be partially stretched or oriented, to enable these packages to be autoclave steam sterilizable, on a device that will outwardly stretch, thermoform, and then retain the three-dimensional article on the mold for heat setting to be accomplished. This solitary device is capable of transforming “off the shelf” PET or APET sheet or roll stock into three-dimensional articles capable of autoclave steam sterilization.

For example, some embodiments of this disclosure involve a process performing the following functions or a solitary forming device capable of performing the following functions: precisely feeding roll stock film or individually cut sheet; clamping said film or sheet along the perimeter with mobile clamps that are capable of retracting to stretch the film or sheet in the outward, planar direction with heating between the clamps; a heating oven to raise the sheet temperature well above its glass transition temperature; a movable mold platen with temperature control capability; vacuum capability optionally with plug assist for precision part definition; and, forced air convection cooling system.

### BRIEF DESCRIPTION OF THE DRAWINGS

The drawings included in this disclosure illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a schematic illustration of a device for gripping and stretching a sheeting or film in accordance with this disclosure.

FIG. 2 is a schematic illustration of a sheet in the grippers after stretching in one direction.

FIG. 3 is a schematic illustration of a sheet in the grippers after stretching in two directions.

### DETAILED DESCRIPTION

The present disclosure may be understood more readily by reference to this description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may have been exaggerated to better illustrate details and features of the present disclosure.

As used herein and in the appended claims, an element or component that “comprises” or “includes” one or more specified components or steps means that the element or component includes the specified component(s) alone or includes the specified component(s) together with one or more additional components. An element or component that “consists of” one or more specified components means that the element or component includes only the specified component(s). An element or component that “consists essentially of” one or more specified components means that the element or component consists of the specified component(s) alone, or consists of the specified component(s) together with one or more additional components that do not materially affect the basic properties of the element or component. Whenever a range is disclosed herein, the range includes independently and separately every member of the range extending between any two numbers enumerated within the range. Furthermore, the lowest and highest numbers of any range shall be understood to be included within the range set forth.

Clear, rigid medical packaging is most often made from an amorphous polyester that has been modified in the polymerization reactor by the resin supplier such that it is no longer crystallizable. The most common version of this amorphous polyester is glycol-modified copolyester (PETG). PETG thermoforms well and has sufficient free volume engineered into its morphology such that it generally retains its strength and clarity after sterilization processes. These sterilization procedures include ethylene oxide and gamma radiation, amongst others, where the elevated temperature during sterilization must remain below the material's glass transition point or package shrinkage and warpage, among other detrimental effects, result. However, PETG cannot be steam sterilized since warping and subsequent package failure from a probable loss in sterility begins to occur near PETG's glass transition temperature of approximately 80 degrees Celsius.

To keep the cost of rigid medical packaging to a minimum, or to tout improved recyclability, certain extrusion companies offer lower-cost alternatives to PETG, such as thermoformable film or sheets made from polyester (PET) or amorphous PET (APET). While the semantics for these materials can be confusing, PET and APET are chemically very close in composition to one another. While the acronym implies a homopolymer, PET often contains between approximately 1 to 2.5% modifier, where the modifier is most often isophthalic acid (IPA). APET historically contains slightly more modifiers than PET at approximately 2.5 to 4.5% modifier content on a molar basis. Similarly, to better codify the chemistry of PET suitable for the stream 1 PET recycle industry (RIC #1, resin identification code for polyesters), the state of California limited the composition of PET or APET as a polyester containing a maximum of 10% “other” modifier beyond the terephthalic acid and ethylene glycol base monomers used to make PET. The higher level of IPA modifier, or other monomer modifiers, in APET slows the rate of crystallization. PET can be extruded up to approximately 0.060 inches thick and remain clear whereas APET can be extruded up to a maximum of about 0.125″. Beyond this thickness, the residual heat from the extrusion process cannot be removed from the extrudate sheet quickly enough, leading to the generation of crystallization. Thermally-induced crystallization usually contains relatively large-sized crystals, which, when present in film or sheet, leads to the generation of haze. For practical purposes, an average crystal size larger than the wavelength of visible light leads to haze. Fully crystallized sheet results in turning the sheet from clear (in its amorphous morphological state) to opaque white in the fully crystallized state. PET sheet extruded below 0.060 inches and quenched quickly is amorphous, clear, and begins to distort at approximately 80 degrees Celsius (the glass transition point for PET). In contrast, a PET sheet that has been thermally crystallized (which is hazy, even to the point of being opaque white) no longer softens or sags during thermoforming at 80 degrees Celsius, but instead, generally retains its stiff shape up to a temperature as high as its melt point of about 245 degrees Celsius for “bottle grade” PET. These approximate values are easily obtained via testing with a Perkin Elmer differential scanning calorimeter (DSC) at a scan rate of 20 degrees Celsius per minute and are well-known by those skilled in the art. Since PET and APET are so close in chemical composition and properties, the PET acronym will be used from henceforth for simplicity but generally describes either or both materials to within a close approximation. The crystallization half times suitable for some aspects of the present disclosure are between 5 seconds and 30 minutes (via DSC or SALLS test methods). In contrast, PETG contains multiples of the aforementioned levels of polymer chain modification (comonomer modification, often between 28 to 33% on a molar standpoint on a diol basis) that renders it as being truly amorphous. PETG cannot be crystallized, evidenced by the fact that it has been extruded at 1 inch thick while remaining clear. The crystallization half-time of PETG is often measured as greater than 10,000 hours when the test is often terminated. PETG therefore shows a glass transition temperature of about 80 degrees Celsius but no melt point during DSC testing since it is essentially amorphous and cannot be crystallized.

The preceding paragraph describes two morphological states of PET: amorphous and crystalline, where the crystallinity has been initiated or allowed to occur, by thermal means. Other routes, such as chemical or solvent means, can also lead to crystallization. Crystals in PET are often relatively large, leading to haze, opacity, and brittleness in articles that have been crystallized. A third or quasi-morphological state can also be obtained. Mechanically stretched or oriented PET leads to small crystallites, also called pseudo-crystals or spherulites. These small pseudo-crystals have the effect of retaining clarity (because the pseudo-crystal size is smaller than the wavelength of light) yet they increase the measured heat distortion temperature to values much above the glass transition temperature of about 80 degrees Celsius because small crystals are present. In addition, the orientation and small pseudo crystals have the added beneficial effect of improving toughness, often well beyond the levels tested with amorphous morphologies. In contrast to PET, when PETG film or sheet is oriented, it forms shrink film, generally without the formation of the small pseudo-crystals. Therefore, PETG, either in the oriented or amorphous state, still cannot be used in applications requiring rigid stability above its glass transition temperature of 80 degrees Celsius. This definition of PETG assumes the optimal amount of modifier has been added such that no crystallization is formed during the DSC test. It should be noted that some casual use of the acronym PETG can, in some instances, refer to modification levels that are not located at the crystallization curve apex and therefore can still be crystallized. This situation would also occur when mixing, for example, 70% PETG with 30% PET, as well as many other ratios, diluting the modifying diol beyond those levels leading to the most amorphous target.

Using methods common to those skilled in the art, rigid medical packaging thermoformed today utilizes PETG, PET, or APET film or sheet that all contain amorphous morphology and therefore process similarly with similar characteristics. Specifically, PETG, PET, and APET film or sheet are all clear and amorphous and are heated to a surface temperature of about 137.8 to about 171.1 degrees Celsius (280 to about 340 degrees Fahrenheit) prior to thermoforming into a rigid medical package. All of these packages made from any of these three substrates would also be clear and retain their shape during sterilization as long as the temperature doesn't exceed about 80 degrees Celsius. Certain protocols for steam sterilization specify 121 degrees Celsius as the target temperature. Clear, rigid medical packages made according to today's methods would not survive this level of steam sterilization. One with limited experience in the art might try to alleviate the aforementioned low-heat distortion temperature of PET or APET by thermally crystallizing the packaging after thermoforming. A PET package can therefore be heated while still on the thermoforming mold to crystallize said article. While thermally induced crystallization can occur at a range of times and temperatures, for PET the maximum rate of crystallization would occur at about 175 to 185 degrees Celsius. After several minutes of heating and subsequent cooling, the resulting article can withstand steam sterilization at 121 degrees Celsius without deformation, but the thermoformed article would no longer be fit for use as rigid medical packaging because it would have become opaque white (no longer clear, which is typically a necessary feature) and it would become brittle. Opaque, brittle packages cannot withstand the various transportation steps between the sterilization facility and the operating room and would break and lose device sterility. Note that this construction is analogous to opaque CPET (crystallized PET) food trays.

Concerning the mechanically stretched or oriented state of PET, when stretched beyond about 4 to 5 times its original dimensions, an effect, herein called strain hardening, can occur. When strain hardening occurs in PET or other semi-crystalline materials, it becomes much more difficult to stretch it farther. Attempts to stretch it slightly farther yield multiple physical property enhancements but significant stretch lengths beyond the strain hardening point often lead to part failure. In embodiments, the present disclosure therefore involves partially stretching the film or sheet via mechanical means (in its two-dimensional or flat form) but leaving the capability of the film or sheet to be stretched farther during the thermoforming process. The point of strain hardening is therefore recognized as almost at the approximate upper limit for this novel process. The sum of the pre-stretching or partial stretching before being formed into a three-dimensional article plus the additional stretching that occurs from the thermoforming process is additive and therefore remains at the strain hardening point in finished articles. This is the upper limit for stretching the crystalline or semi-crystalline substrates.

Similar to an upper stretching limit, a lower stretch limit is also involved with the present disclosure. As an extreme example, a film or sheet that has not undergone any intentional stretching prior to thermoforming does receive a small but insufficient amount of stretching during thermoforming to give the desired high-temperature properties. However, the normal thermoforming process does not stretch the PET film enough to generate enough of the pseudo crystals so articles made from amorphous, non-stretched PET sheets will still distort in environments above 80 degrees Celsius. When an article made from PET is thermoformed in this manner, without pseudo crystals, when exposed to autoclave steam sterilization, the article will both significantly distort and will turn from clear to hazy/opaque white from large crystal formation. It would also be brittle.

A film or sheet substrate naturally possesses the three dimensions of length, width, and height (or thickness). However, for the current disclosure, these substrates will be referred to as having two dimensions where the height or thickness of said film or sheet has not been altered as made (extruded, calendered, blown, etc.). The planar direction of the film or sheet can be expressed herein as the x- and y-directions in Cartesian or Gaussian coordinates and the height or thickness as the z-direction. The two-dimensional film or sheet remains flat as made. In contrast, a three-dimensional film, sheet, or article is defined as a two-dimensional film or sheet that has been manipulated such that the height of the planar film or sheet has been altered in the z-direction, different from which it was originally made. Manipulation means thermoforming, vacuum forming, pressure forming, drape forming, matched mold forming, forming with a plug assist, etc., where the (optional) heating, stretching, and subsequent (optional) cooling steps add contours in the z-direction that are at least 10% out-of-plane versus how the flat film or sheet was initially made.

In some embodiments of the present disclosure, molten polymeric film and sheet comprise and contain linear or branched polymeric strands that are generally deposited in random orientations when deposited under low- to no-stress environments, leading to isotropic properties. These molten films or sheets are quickly quenched to freeze the molecular orientation in the random state, leading to high clarity in the film or sheet. Herein the term “quickly quenched” refers to cooling the molten polymer to or below its glass transition temperature in a time period that is a small fraction of its crystallization half-time for crystalline or semi-crystalline polymer types. In certain conditions where the film or sheet is not quickly quenched, crystals can form from this thermally-activated mechanism which grows to a relatively large size. When the large-sized crystal is larger than the wavelength of visible light (400 to 700 nanometers), visible light is scattered in non-randomized directions which leads to haze and eventually opacity when the size and quantity of large crystals exist. It is the purpose of the present disclosure to avoid large crystals leading to haze and possible opacity from crystal sizes larger than about 2000 nanometers, 1500 nanometers, 1000 nanometers, or more preferably 700 nanometers or most preferably the crystal sizes are below 400 nanometers. Clarity is best maintained when the size of crystals, crystallites, pseudo-crystals, or spherulites is below 400 nanometers. For the purposes of the present art, a crystal is herein defined as non-random polymeric strands with initially high free volume or interstitial pocket void space between the polymer strands which subsequently become more ordered or stacked into smaller areas that have densified to possess less than the maximum amount of free volume and which now, post crystallization, contain a higher fraction of both dipole and van der Waals force interactions between the adjacent polymer strands, leading to non-linear measurements during DSC testing at constant energy input. These crystals also have a true melt temperature that is higher than the glass transition temperature of the randomized, non-oriented sections of the polymer, measurable and quantifiable during DSC testing. Crystallites, pseudo-crystals, or spherulites are herein defined as small crystals, less than 700 nanometers in size, that also manifest themselves during DSC testing by affecting non-linear measurements during DSC testing at constant energy input whereas a completely amorphous or randomized arrangement of polymeric strands does not show a melt point but only a glass transition temperature during the first DSC scan.

In one embodiment, the crystal size is measured as the radius of the calculated hydrodynamic volume. In other embodiments, since the film can be intentionally stretched or some degree of orientation in the film is generated during film neck-down as the extrudate exits the die, the crystal size is measured as the length of the longest direction according to the crystal's aspect ratio. In other embodiments, the crystal size is measured as the length of the shortest direction according to the crystal's aspect ratio. In other embodiments, the crystal size is measured as the average of the dimensions for the crystal's aspect ratio. In other embodiments, the crystal size is limited to a maximum based on the physical properties of the film or sheet. In other words, physics dictates that a crystal size is below 400 nanometers when an article remains clear, yet crystals are known to be present based on the measured heat distortion temperature or testing by differential scanning calorimetry (DSC). In embodiments, the crystallization mechanism mentioned above can also occur due to mechanical forces being induced in a film or sheet under certain environmental conditions. These pseudo-crystals, induced by mechanical means tend to be smaller and more easily controlled via mechanical means than thermal means. When the mechanical force or stretching occurs in one direction, whether that be in line with the extrusion direction, herein called machine direction orientation, or across the film or sheet web, herein called the transverse direction orientation, usually leads to anisotropic properties. The force to tear the film, for example, will be different when torn in the general direction of the orientation versus a tear force measured perpendicular to the direction of orientation. Similarly, anisotropic sheet properties often lead to undesired preferential, directional shrinkage during thermoforming. It is therefore a preferred embodiment of the present disclosure to stretch or orient the film or sheet in both the x- and y-directions in a bi-axial manner to better maintain isotropic properties, of which the tear force and uniform shrinkage during thermoforming previously mentioned are two of many properties thusly affected.

Under certain aspects of the present disclosure, it is expected that a small amount of haze might be present on some limited portions of the three-dimensional package after steam sterilization. For example, with a film that has been stretched 2.5 times its original dimensions and then thermoformed, it is recognized that the package design, specifically the depth of draw or lack thereof, becomes a factor. In areas where the pre-stretched film is farther stretched, the small pseudo-crystal formation will be maximized. However, on other parts of the same package, little to no additional stretching might occur (i.e., on flat parts of the package). These parts of the package will contain some quantity of pseudo crystals but will not be as close to the strain hardening point as the part of the package that required more stretching. Such a part could still warp when exposed to elevated temperatures. While not obligatory for this art, in some aspects of the current disclosure it is a preferred practice to heat set the article while it remains on the mold at or above the intended use temperature. For example, under one sterilization protocol, autoclave steam sterilization occurs at 121 degrees Celsius. Articles undergoing this protocol should be thermoformed and then heat set at, for example, 125 degrees Celsius, or higher, for seconds up to several minutes. Performing this step before steam sterilization will lead to a part that remains relatively warp-free, generally clear, and retains its tough characteristics.

It should be noted that steam sterilization is not an obligatory endpoint for the current disclosure. Articles made from pre-stretched sheets then thermoformed, then heat set, leads to an overall tougher product than packages made from amorphous PET or PETG film or sheet. Similarly, heat setting is also an optional element for this art. Articles made from pre-stretched sheet, then thermoformed, without heat setting also yields an overall tougher product than packages made from amorphous PET or PETG film or sheet. In other words, PET that has been partially or fully oriented generally has higher instrumented impact values than PET or PETG that has not been oriented when tested according to ASTM D3763. Further, the final article in the present art need not be intended exclusively for rigid medical packaging. Any thermoformed article with three-dimensional character using a pre-stretched sheet is applicable in the current disclosure.

In embodiments of the current disclosure, the performance of packages exposed to sterilization methods at elevated thermal conditions is improved. This is true for packages exposed to not only steam sterilization but also for sterilization methods not utilizing steam. For example, in ethylene oxide sterilization (EO or ETO), an elevated thermal climate is used with amorphous packages, but the temperature must remain below the material's glass transition temperature. In the current disclosure, the presence of the small spherulites enables increased temperatures during ETO sterilization (i.e., more severe sterilization protocols) and other sterilization methods which can result in faster sterilization cycle times, higher efficacy post sterilization (fewer sterilization cycles or repeated processing from undesirable biological indicator results) and a tougher part since sterilization above the material's glass transition temperature leads to reduced or essentially no aging in the amorphous regions between the spherulites. The preceding description focused on PET packages because medical-grade PET resin tends to be less expensive than medical-grade PETG resin, yet packages made with PET according to the process described herein often result in a package with superior properties when compared to PETG, which has heretofore been recognized as the preferred material for use in clear, thermoformed rigid medical packaging. Oriented film or sheet from other semi-crystalline polymers also yield similar or better properties as oriented film or sheet from PET but perhaps at a higher raw material price point. Concerning other sterilization methods, the phrase “chemically-activated” sterilization is used and includes, but is not limited to, chlorine dioxide, peroxide, peracetic acid, formaldehyde, ozone, performic, alcohol, etc. In this context, it is recognized that ethylene oxide is also a “chemically-activated” sterilization method. It has been previously highlighted due to its prevalence in the sterilization industry.

In embodiments of the present disclosure, the suitable crystalline or semi-crystalline polyesters can be either aromatic or aliphatic in nature and comprise, but are not limited to, polyethylene terephthalate (PET), amorphous polyethylene terephthalate (APET), glycol-modified polyethylene terephthalate (PETG), acid-modified polyethylene terephthalate (PETA), Polycyclohexylenedimethylene terephthalate (PCT), glycol-modified Polycyclohexylenedimethylene terephthalate (PCTG), acid-modified Polycyclohexylenedimethylene terephthalate (PCTA), polyethylene naphthalate (PEN), polyethylene furanoate (PEF), Polytrimethylene terephthalate (PTT), polybutylene terephthalate (PBT), polybutylene naphthalate (PBN), polybutylene adipate-co-terephthalate (PBAT), polytretramethylenecyclobutylene terephthalate (PCTM), polycyclohexanedimethyl cyclohexanedicarboxylate (PCCD), polycyclohexylene dimethylene cyclohexanedicarboxylate (PCCE, copolyester ether elastomer), polycyclohexanedimethylene-co-isosorbide terephthalate, and copolymers, isomers and blends thereof.

In embodiments of the present disclosure, the polymeric composition contains both primary and secondary diol or diacid modifying monomers and additional comonomers, including multi-functional branching monomers, either aromatic or aliphatic in nature, and comprise cyclohexane dimethanol, butanediol, propanediol, neopentyl glycol, spiroglycol, isosorbide, 2,2,4,4-tetramethyl-1,3-cyclobutanediol, diethylene glycol, ethylene glycol, bisphenol A (BPA), branchers (TMA), pentaerythritol or polyethylene glycol (PEG).

In embodiments of the present disclosure, the diol component of the polyesters in the blends of the disclosure may contain up to 10-mole percent of the residues of a modifying diol. Examples of modifying diols include propylene glycol, 1,3-propanediol, 2,4-dimethyl-2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, 1,4-cyclohexanedimethanol, p-xylylene glycol, polyethylene glycol, diethylene glycol, polytetramethylene glycol, 2,2,4,4-tetramethyl-1,3-cyclobutanediol, and combinations thereof.

In embodiments of the present disclosure, one, two, three, or more dicarboxylic acids which may be used with terephthalic acid include phthalic acid, isophthalic acid, furandicarboxylic acid, (FDCA), 1,4-, 1,5-, 2,6-, and 2,7-naphthalenedicarboxylic acid, 1,3-, 1,4-cyclohexanedicarboxylic acid (which may be cis, trans or a mixture thereof), cyclohexanediacetic acid, trans-4,4′-stilbenedicarboxylic acid, 4,4′-oxydibenzoic acid, 3,3′- and 4,4′-biphenyldicarboxylic acids, malonic acid, succinic acid, glutaric acid, adipic acid, azelaic acid, sebacic acid, suberic acid, pimelic acid, nonane, decane, dodecanedicarboxylic acids. The copolyester may be prepared from one or more of the above dicarboxylic acids. It should be understood that the use of the corresponding acid anhydrides, esters, and acid chlorides of these acids is included in the term “dicarboxylic acid”. The “residue” of the dicarboxylic acids described herein is that portion of the diacid which constitutes a portion of a diester of the diacid. The diacid residues may be derived from the dicarboxylic acid, dialkyl esters thereof, e.g., dimethyl terephthalate and bis(2-hydroxyethyl) terephthalate, acid chlorides thereof and, in some cases, anhydrides thereof.

In embodiments of the present disclosure, rigid medical packaging is desired to have optimal clarity and brightness as measured by the Hunter Lab, ASTM E308, or CIELAB L* value as high as possible. The highest L* values are obtained when utilizing PET resin that contains no reheat aids. Without reheat aids, favorable L* brightness values on a 1 mm thick sheet are preferred to measure at least 65, or more preferred at least 75, or most preferred above 85. The reheat aids often used in bottle processing, herein preferably to be avoided, include Fe₃O₄, carbon black, reduced antimony, etc. Typically, embodiments of this disclosure result in articles that have a haze value of less than 10% (or less than 8%) as measured by ASTM D1003 and/or a measured light transmission of greater than 70% (or greater than 75%) as measured by ASTM D1003, and the article retains one or both of these properties even after heating to a temperature above the glass transition temperature but less than the melt temperature of the thermoplastic polymer from which the article is formed.

In embodiments of the present disclosure, packaging might also preferably utilize PET with catalyst systems that avoid elements of concern, including heavy metals as listed by CONEG (Coalition of Northeastern Governors) and elsewhere. Since antimony-based catalysts are most often used in the manufacture of PET resin, instances can be cited where antimony-free PET residues are preferred.

In embodiments of the present disclosure, the polyamide composition can contain both primary and secondary diamines or diacid-modifying monomers and additional comonomers, including multi-functional branching monomers, either aromatic or aliphatic in nature.

The polymer blends of the disclosure may further comprise one or more additives in amounts that do not adversely affect the resulting blend properties. Examples of additives include antioxidants, melt strength enhancers, chain extenders, flame retardants, fillers, acid scavengers, dyes, colorants, pigments, anti-blocking agents, flow enhancers, impact modifiers, antistatic agents, processing aids, mold-release additives, plasticizers, slip agents, stabilizers, waxes, UV absorbers, optical brighteners, lubricants, pinning additives, foaming agents, nucleators, glass beads, metal spheres, ceramic beads, carbon black, cross-linked polystyrene or acrylic beads, and the like. Colorants, sometimes referred to as toners, may be added to impart a desired neutral hue and/or brightness to the polyester blends. Representative examples of fillers include calcium carbonate, talc, clay, mica, zeolites, wollastonite, kaolin, diatomaceous earth, TiO₂, NH₄Cl, silica, calcium oxide, sodium sulfate, and calcium phosphate. Titanium dioxide and other pigments or dyes may be included. In another embodiment, crystallization seeding is employed utilizing various additives including linear low-density polyethylene or polypropylene additives.

In embodiments of the present disclosure, the crystalline or semi-crystalline polyesters can have an inherent viscosity (IV) ranging from about 0.5 to about 1.2 dL/g, when measured at 25 degrees Celsius using 0.50 grams of polymer per 100 mL of a solvent consisting of 60 weight percent phenol and 40 weight percent tetrachloroethane as generally described in ASTM Method D2857-95.

The glass transition temperature can be measured by conventional methods. For example, the glass transition temperature of the crystalline or semi-crystalline polyesters can be measured according to ASTM D 3418.

In one aspect of the present disclosure, the branching agent comprises a multifunctional acid or multifunctional alcohol having at least three acid or alcohol groups or a combination of acid and alcohol groups including, but not limited to, trimesic acid, trimellitic acid, citric acid, tartaric acid, trimellitic anhydride, pyromellitic dianhydride, trimethylolpropane, glycerol, pentaerythritol, citric acid, tartaric acid, 3-hydroxyglutaric acid or mixtures thereof. In another aspect, the branching agent comprises an epoxide, including, but not limited to, glycidyl methacrylate. In another aspect, the branching agent comprises a dendritic polymer having at least three reactive functional groups such as carboxylic acids, esters, hydroxyl, or combinations thereof.

It has also been found that other clear, semi-crystalline polymers can be mechanically oriented and yet are thermoformable when processed according to the methods described in the present disclosure. In addition to polyesters, other suitable crystalline and semi-crystalline polymers include polyamides, polyurethanes, polystyrene, polypropylene, cyclic olefin polymers, and copolymers (COP/COC), polyarylates, polycaprolactone, polylactic acid (PLA), and copolymers, combinations, and blends thereof.

While the use of recycled material may contain a small percentage of contamination, this contamination has been shown to be of a low amount (less or equal to 2%) such that the required orientation level for packages made according to the current disclosure is often unaffected. Therefore, film and sheet utilizing either virgin-sourced resin or recycled content, or blends thereof, are suitable for the current disclosure.

The film or sheet utilized in the disclosure can be produced by a variety of methods. One method is extrusion which includes the traditional extrusion of a molten polymer extrudate through an optional coat hanger die with a three-roll cooling roll stack. Other suitable methods are film or sheet casting, also involving molten extrudate through a heated die, usually with a two-roll cooling stack where the film is optionally pinned to the cooling roll with an air knife or via electrical/static pinning methods. The film or sheet could alternatively be made via blown film extrusion where the molten extrudate is pushed through an annular die, often with cooling air forced through the center of the film tube, often without any cooling rolls being present. Some degree of pre-stretching can occur during the blown film extrusion process.

Besides extrusion, film suitable for use in this disclosure could also be made via a calendering process. This method is not preferred due to the crystalline or semi-crystalline nature of the polymer in use without the use of additives or modifiers to slow or prevent the crystallization induced during the process.

While a significant portion of the disclosure assumes a focus on orienting a monolithic film or sheet substrate, occasions arise where a coating or a thin co-extruded cap layer is needed to impart properties to the film or sheet's exterior surfaces. This could include an aqueous silicone coating which can be sprayed, roll-applied, or passed through a doctor blade to remove excess solution before drying. Alternatively, a co-extruded cap layer containing the densest additives which alter the coefficient of friction and diminish film-to-film surface blocking, or ultra-violet inhibitors to slow weathering in exterior environments, etc., can also be applied. While the silicone coating is much thinner, the co-extruded cap layers are typically 0.002 to 0.004 inches thick and are located on one or both exterior surfaces. This disclosure includes film or sheet configurations that are either monolithic or contain one or two exterior cap layers or coatings.

Once the film is produced, it next needs to be partially oriented. The methods of partial orientation suitable for certain aspects of this disclosure include both in-line and off-line or secondary processes. In-line orientation methods include traditional machine-direction orientation (MDO), transverse-direction orientation (TDO), diagonal-direction orientation (DDO), combinations thereof being orientation in both directions (bi-axially oriented film or sheet). These same in-line orientation methods can alternatively be used offline, post-extrusion in a different time and place as extraction. Other secondary processes involve batch-type stretching or tenter frames, or thermoforming machines that have pre-stretching capabilities built into the design. Such thermoforming machines could optionally utilize PET film or sheet made in the traditional manner with no pre-stretching involved (in the film roll stock as received), prior to the pre-stretching that occurs on the thermoforming machine just before thermoforming the now stretched film or sheet into a three-dimensional article.

While stretching the film or sheet normally occurs at a temperature set point that is about 10 to 15 degrees Celsius higher than the Tg, Embodiments include stretching at temperatures beyond this traditional level. Higher temperatures are optionally needed for the thickest of film or sheet. This can be due to limited heat transfer to the center thicknesses on thick substrates and also due to torque equipment or side grip/clamp limitations during stretching. As such, common film or sheet thicknesses for clear, rigid medical packaging are often 0.010 inches to 0.060 inches (about 0.25 mm to about 1.5 mm) but more typically 0.025 inches to 0.040 inches (about 0.64 mm to about 1.0 mm). Because the stretching process thins the film or sheet, initial or pre-stretched sheet thicknesses are as high as 0.090 inches (about 2.3 mm), but average 0.065 to 0.070 inches (about 1.65 mm to about 1.78 mm). Past stretching processes applied only to relatively thin sheets (starting thickness of less than 1.0 mm, and often less than 0.7 mm). Accordingly, such a stretching process could not both adequately stretch the sheet and achieve the desired thickness for packaging. For example, the starting thickness might be from 0.4 mm to 0.6 mm and have a final thickness of 0.15 mm to 0.2 mm, which as indicated above is thinner than desired for medical packaging. Advantageously, the processes of this disclosure can be applied to sheets of 0.5 inches (about 12.7 mm) or less. For example, the sheets can be from 0.01 inches to 0.50 inches (about 0.25 mm to 12.7 mm). For example, the sheets can have a starting thickness (pre-stretch) of from 0.7 mm to 2.0 mm, or from 1.0 to 2.0 mm, or from 0.7 mm to 1.5 mm or from 1.0 to 1.5 mm. The post-stretch thickness of such films under the current disclosure could be, for example, 0.5 mm to 1.0 mm. It should be noted that the stretching or orientation process is almost additive when comparing a film stretched in one direction versus two-directional or bi-axial stretching. For example, a film stretched 1.65 times in one direction and then stretched 1.65 times in a second, planar direction approximates some film properties of a uniaxial film stretched at 2.7 times its starting length.

In embodiments, a practitioner of film orientation will expect the film to become thinner as it is stretched. Similarly, as a film is stretched in one direction, using the MDO process as an example, the film will also neck down or become narrower versus its initial width. Lastly, oriented crystallization also has a densification effect on the overall film density. Results have shown that orienting the film is approximately divided equally among these three mechanisms. Therefore, as an example, a film that is stretched 1.65 times on an MDO line with an initial starting thickness of 0.065 inches and 24 inches wide necks down to 19.5 inches wide, and the film thickness becomes about 0.053 inches. Roughly a third of the initial film volume involves thinning, a third involves width narrowing and a third is lost due to crystallization, evidenced by densification. While one might expect an initial starting thickness of 0.065 inches, stretched at 1.65 times, to become 0.039 inches thick from linear mathematical calculations, this is not correct.

In embodiments, strain hardening of the film or sheet substrate can result in a substrate stiffness that results in poor shape definition during regular vacuum forming. In these situations, it is a preferred practice to use additional force, beyond vacuum, to manipulate the strain-hardened substrate to fill a mold cavity. While not being bound to these methods, a plug assist, especially with tight tolerances compared to the mold cavity, and/or pressure forming, using high-pressure air or another gas, and/or a hydraulic bladder to contact one side of the sheet and thus force the substrate into a proper shape. Similarly, a matched mold with upper and lower molding surfaces, usually with a nested design with specific tolerance, aids in proper part manufacture. Proper tolerances for the above conditions include a maximum of about 0.3 inches (about 7.62 mm), but preferably 0.1 inches (about 2.54 mm) between the surfaces. Another calculation of proper tolerances would be a maximum of 0.05 inches (about 1.27 mm) thicker than the pre-formed film or sheet thickness, or preferably 0.030 inches (about 0.76 mm), or preferably 0.020 inches (about 0.51 mm), or more preferably 0.010 inches (about 0.25 mm), or most preferably 0.005 (about 0.13 mm) inches thicker than the formed film or sheet.

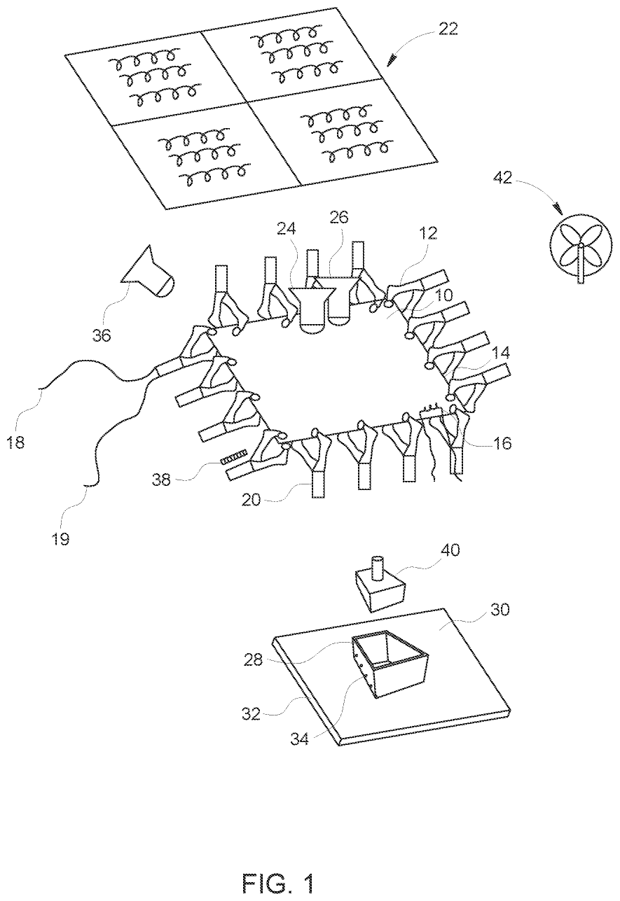

Referring to FIGS. 1 to 3, aspects of this disclosure can be better understood. The figures illustrate an example of a design for a device for stretching a film or sheet in accordance with this disclosure.

FIG. 1 shows a schematic basic design for the device. In the device, sheet 10 is secured on all four sides by grippers 12 such that, on each side, a plurality of grippers secures the sheet. Unlike traditional thermoforming machines which use solid bars, often with sharp projections to help hold the sheet, the disclosed device uses grippers which intentionally allow heat to flow between the grippers to the sheet to be processed. An intentional open space of 14 is left between neighboring grippers. The open space 14, or lack of shielding, between the grippers, can improve isotropic article processing. Note the openness, allowing heat to hit the sheet, versus the traditional clamping bar which blocks heat from reaching the film that is clamped. An optional heater 16 can be used between the grippers to keep the sheet between the grippers at the proper temperature set point. Temperature-controlled fluid can be provided to the inside of the grippers through optional inlet 18 and outlet 19. Tensiometers 20 can be affixed to each gripper for improved precision and monitoring of the grip strength. An oven 22 is positioned so that its heaters heat sheet 10. Optionally, the device can include an optical analyzer 24 and a polarizing spectrometer 26 for quality control and inspection. A mold element 28 can be mounted on by channels onto a hollow platen 30. Vacuum hose 32 connects platen 30 to a vacuum pump so that the vacuum pump is in fluid flow contact with a plurality of vacuum holes 34, which are oriented close to a part of mold element 28. The vacuum produces an inward or negative radius, to improve pulling the sheet to the mold so that the final thermoformed part closely matches the shape of the mold. To further aid proper shape retention, plug assist 40 is used to aid in pushing the sheet into mold element 28″.

In operation, a thermoplastic sheet 10 is loaded into the stretching area and held in place by closing grippers 12. The grippers 12 then move sheet 10, without stretching it, under the oven 22 until the sheet surface temperature reaches the set point via measurement with a temperature indicator, optionally an infrared temperature indicator 36. When the temperature is approximately 10 degrees Celsius above the material's set point, grippers 12 are moved outward to stretch sheet 10 according to the preprogrammed length as measured by the distance measurement device 38. Besides distance, an alternative amount of stretching can occur until a preprogrammed force is reached according to each gripper as measured by each individual tensiometer 20. This stretching procedure occurs at a rate of approximately 3 inches per second for PET but is programmable for this or other substrate chemistries. Having now been stretched, sheet 10 will next be thermoformed. Since thermoforming often occurs at a temperature higher than stretching, the sheet remains in oven 22 to achieve this higher temperature. Sheet 10, still under the oven 22, remains in place until the next temperature set point is reached (approximately 70 degrees Celsius above the material's glass transition temperature). The mold 28 then moves upward to meet sheet 10, still while under oven 22. Grippers 12 then push sheet 10 over mold 28. A vacuum is applied via the vacuum hose 32, through the vacuum holes 34 so that the mold shape is accurately transferred to sheet 10. Note grippers 12 have pulled the sheet slightly below the plane created by mold platen 30, ensuring a good thermoforming seal. Further, plug assist 40 is used to force the sheet into the proper shape in the mold, especially useful in cases where the sheet modulus has significantly increased due to strain hardening. While this operation was occurring, cooling fluid can be flowed through the cooling tubes by introduction through inlet 18 and removal through outlet 19 to keep grippers 12 cool. At this point, the shaped article, still on the mold, remains in place for several seconds to minutes to heat set and, in some embodiments, to complete the crystallization step needed for some applications. At this point, heating the article for heat setting can be achieved by the oven with optional temperature control of the mold itself. After the preprogrammed amount of time, mold 28 lowers, and a forced circulation cooling fan 40 turns on to slightly cool the article. Grippers 12 then release, allowing the article to be extracted.

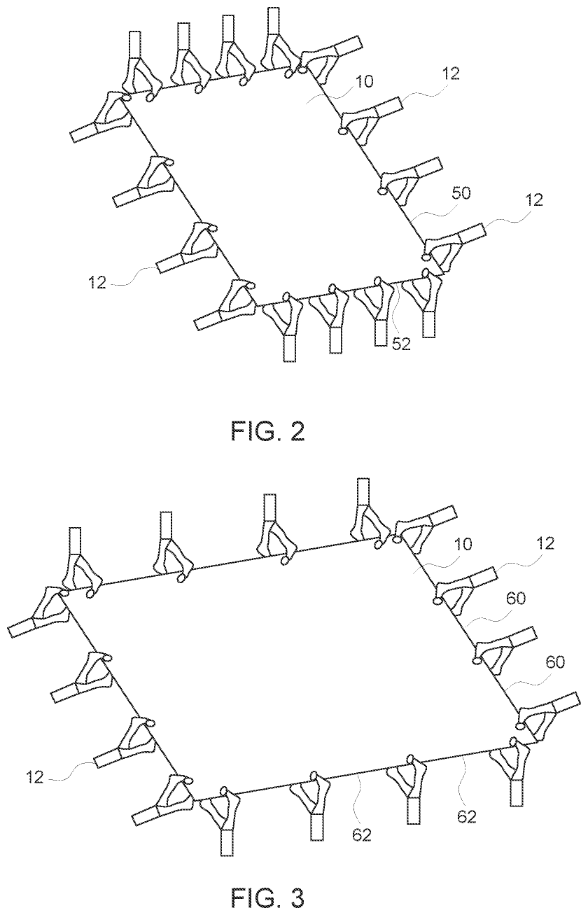

In the description above, when sheet 10 is stretched, this optionally can occur in a one-directional stretch (FIG. 2) where open space 50 between grippers 12 in the direction of the stretch is longer or wider than open space 52, in which no stretching occurs. Similarly, when sheet 10 is stretched, this can alternatively occur in a two-directional stretch (FIG. 3) where open spaces 60 and 62 for both directions of stretch are wider than for the non-stretch direction in FIG. 2. Note that open spaces 60 and 62 can be equal in length but alternatively do not have to be equal. Further, since individual grip distance is adjustable at each location on sheet 10, open space between neighboring grippers 12 on a side can but are not required to be equal. With individual location stretching control, grip space around the perimeter of sheet 10 can all be the same or different according to the targeted properties for each individual article.

Prior art forming systems employ a fixed clamping system where the bar that clamps the sheet intentionally shielded the entire perimeter of the sheet from the oven heat to keep the plastic's edge below the glass transition temperature. When the sheet perimeter is kept cool, the clamps tend to hold the sheet in place during the forming process. The key concepts of traditional forming just mentioned include a fixed or non-retractable clamping system and clamping bars which shielded the entire sheet perimeter. The mobile grippers of this disclosure necessitate a sheet temperature between the grippers to be above the glass transition temperature, preferably at a temperature close to the surface temperature at the interior of the sheet. In addition, grippers are used, instead of a clamping bar, so the grippers can retract in the outward planar direction of the film or sheet (herein jointly referred to as “sheet”) to stretch it right before or during the thermoforming into a three-dimensional article. When the plastic blank exceeds its glass transition temperature, the grippers retract in the outward planar direction to stretch or partially orient the sheet, enlarging its length and width while simultaneously thinning the substrate. For the sheet to possess isotropic properties, the grippers must not only retract outwardly but the spacing between the grippers must also increase; hence, the need for the film or sheet between the grippers, at the sheet perimeter, to be above the sheet's glass transition temperature and close to the same surface temperature targeted for the substrate's interior.

In embodiments of the present disclosure, the device can have a programmable feature that the planar sheet outward stretching step and the three-dimensional shape forming step (z-direction stretching in Cartesian or Gaussian coordinates, caused by contact with the mold) occur simultaneously or occur sequentially where the outward stretching step occurs prior to the z-direction shape forming step. Alternatively, the steps can occur sequentially where the outward stretching step occurs, then additional heating is provided to further raise the sheet surface temperature, and then the z-direction shape forming step is activated. Further, for the sheet that resists z-direction forming, a plug assist or matched mold can be used to force the sheet into the desired shape.

In the embodiment of the present disclosure, the device is designed to avoid shielding the perimeter of the sheet between the clamps so these areas can properly heat and stretch. In embodiments, the device can contain heating elements preferentially positioned or aimed between the grippers, to ensure the sheet perimeter achieves the localized, target temperature.

In embodiments, the outward planar stretching can occur when the sheet is just above the glass transition temperature of the sheet so stretching is programmed to occur while the sheet is still in the oven. The location of the stretching is important because additional sheet heating is needed prior to z-direction, three-dimensional forming on the mold. In some embodiments, stretching occurs at about 10 to 15 degrees Celsius beyond the glass transition temperature while z-direction stretching occurs at about 70 degrees Celsius above the glass transition temperature.

In another embodiment, the three-dimensional article, after having been stretched and formed, is left on the mold for heat setting, which normally occurs at about 170 to 180 degrees Celsius for PET for up to about 10 minutes. One skilled in the art will notice that the heat setting temperature is above the glass transition temperature for the sheet. When amorphous materials are crystallized (or exposed to elevated temperatures), any heat setting step above the material's glass transition temperature would cause the sheet to stick to the mold. This does not occur with PET because the outward stretch step causes spherulites to form, raising the article's use temperature above its glass transition temperature. The stretching function therefore enables device programming for heat setting above the glass transition temperature that previously could not occur.

In embodiments, the grippers can be cooled to better ensure the sheet is properly held during outward planar stretching and three-dimensional z-direction forming.

In embodiments, the device can have the ability to retract the grippers on all four sides for bi-axial outward stretching. In another embodiment, the novel device is programmed to retract the grippers on two opposing sides for x-direction only or y-direction only outward stretching for situations where anisotropic properties are desired.

In embodiments of the current disclosure, each gripper can be independently controlled and programmed where that specific “latitude” can be independently stretched more or less than the adjacent or other grippers. This feature is important for situations where an on-line thickness measurement of the sheet indicates that more or less stretching is required along a localized latitude or longitude. In this instance, latitude and longitude are defined as straight lines formed in either the x or y directions by coupling a gripper on one side of the sheet to an opposing gripper on the opposite side of the sheet.

In embodiments of the current disclosure, each gripper can be independently controlled such that movement is programmable in both the x and y directions but also in the z-direction. This optional feature allows a mold to remain in a fixed position while the grippers can both outwardly stretch in the x and y directions but also pull the hot sheet to be formed over the mold in the z-direction.

In embodiments of the current disclosure, the new device can accept feedstock of both individual sheet pieces as well as continuous rolls of sheet.

In embodiments of the current disclosure, the new device can possess the capability to measure the outward force at each gripper such that it can be programmed to stretch according to a certain pull force instead of an assumed sheet thickness. For context, the sheet that pre-possesses some degree of orientation tends to have a higher tensile modulus and requires less stretching before forming to achieve the desired properties. In addition, a correlation can be calculated between the pull force on the film and the degree of orientation in the film for a given thickness and substrate chemistry. This tensiometer type of reading and control will also allow one skilled in the art to better measure the point when strain hardening occurs.

In embodiments, the length of outward travel for each gripper can be measured and programmable. In embodiments, a polarizing spectrometer can be utilized to measure such properties as non-uniform, localized strains and stresses. In embodiments, an optical analyzer can be used to measure the size and quantity of visual defects including gels, black specks, white specks, and other possible contaminants.

In embodiments, forming and/or thermoforming can be used interchangeably to include thermoforming, vacuum forming with optional plug assist, pressure forming, drape forming, matched mold forming, or compression molding.

In embodiments of the current disclosure, the z-direction of forming occurs between a set of matched molds.

In embodiments of the current disclosure, the z-direction of forming occurs between a hydraulic bladder and one mold.

In another aspect of the present invention, the process of orienting the sheet package lessens undesirable webbing that might occur during thermoforming. Webbing occurs when a material stretches excessively during the thermoforming process. Several different factors can be involved, including excessive heat in the localized zone which facilitates excessive stretching in the localized area, allowing the rubbery film to fold on itself. In the present invention, if the partially stretched film has not been heat set to remove the internal stresses, the sheet can temporarily shrink and pull tight in the grippers right before and during thermoforming, thus lessening the propensity to form undesirable webbing.

In another aspect of the present invention, the grippers hold the sheet with equal spacing prior to the stretching step. The spacing between one gripper and the adjacent gripper can be 0.25 inches, or 0.5 inches, or 1 inch, or 1.5 inches, or 2 inches, or 3 inches, or 4 inches, or 5 inches, or 6 inches, or 8 inches, or 10 inches, or 12 inches.

In another aspect of the present disclosure, the multi-step process of orienting the package enhances the toughness. Articles made according to the prescribed procedure have higher energy at maximum load values than the amorphous, non-oriented packages when tested according to ASTM D3763 or the Bruceton staircase method.

In another aspect of the present disclosure, the multi-step process of orienting the package enhances the strength. Articles made according to the prescribed procedure have higher tear force than the amorphous, non-oriented packages when tested according to Elmendorf Tear Resistance testing, ASTM D1922 or Trouser Tear Resistance @200 mm/min, ISO 6383-1). Similarly, testing of non-oriented APET sheets exhibited a tensile strength at the yield point of about 8,200 psi whereas oriented APET tested at approximately 25,000 psi, over a 200% improvement.

In another aspect of the present disclosure, the multi-step process of orienting the package increases the tensile and flexural moduli according to ASTM D638 and ASTM D790, respectively. Specifically, testing of non-oriented APET sheets exhibited a tensile modulus of about 320,000 psi whereas oriented APET tested at approximately 720,000 psi, an improvement of over two times. This feature, when coupled with the increased toughness, leads to the ability to downgauge the product without sacrificing toughness and package sterility. Downgauging, when utilized, can lead to several improvements such as lower package weight (material and shipping advantages) and faster thermoforming cycle times (lower energy per part produced).

In another aspect of the present disclosure, the multi-step process of orienting the package slows the vapor transmission rate. Testing of the non-oriented APET sheet exhibited a moisture vapor transmission rate of about 4.0 (g/100 in²·24 h) versus 2.0 for the oriented APET sample. Oxygen Permeability was likewise 13 and 5 (cm³·mil/100 in²·24 h·atm), respectively.

In another aspect of the present disclosure, the multi-step process of orienting the package improves the chemical resistance. While not wishing to be bound by theory, this feature is believed to occur from the reduced chemical permeability from oriented polymer chains and an increase in the fraction of impermeable pseudo crystals or spherulites. Such spherulites represent impermeable barriers for which chemical migration, through random diffusion mechanisms, must move around for deeper penetration into the article, often possessing lower free volume with fewer interstitial areas for said chemical molecules to reside. Traditional packaging made from amorphous PET or PETG both can experience situations where a damp ethanol cloth, for example, is used to clean the package. In certain situations, this ethanol exposure can cause chemical attack and crazing which may manifest itself as microcracks in the package. These microcracks weaken the package and cause concern for sterility retention.

In another aspect of the present disclosure, the multi-step process of orienting the package improves the Q10 factor where the package physically ages during sterilization at a slower rate versus non-oriented, amorphous morphologies. Traditional packaging made from amorphous PET or PETG both undergo physical polymeric aging where toughness decreases as densification increases from molecular rearrangement, leading to a decrease in total free volume. One skilled in the art would understand that the propensity for crack propagation, leading to package failure, increases as total free volume decreases. The multi-step stretching process in the current disclosure, leading to pseudo crystals or spherulites, acts similarly to a low-density cross-link, slowing polymer chain rearrangement and thus improving physical aging as measured by ASTM F1980-02 and similar methods. Additionally, it should be noted that densification or physical aging increases as the delta or difference between the “room” temperature and the material's glass transition decreases. The room temperature is herein defined as the environment in which the article or package is maintained. However, physical aging is reset when a package or article's effective age becomes essentially zero when the room temperature exceeds the material's glass transition temperature. For those skilled in the art, it would therefore be an optional goal to have a package exceed its glass transition temperature so that an effective zero age, and therefore the highest attainable toughness, is maintained. However, since amorphous articles also warp and sag under this condition, this process cannot be completed on amorphous PET or PETG since the package would be distorted and ruined. In contrast, under the present art, the oriented and heat set package can experience a temperature above the material's glass transition temperature because the pseudo crystals or spherulites essentially hold the package shape together with minimal or non-existent warpage. In summary, in one embodiment of the current disclosure, the room temperature is preferred to exceed the material's glass transition temperature because the amorphous sections of the article or package, around the pseudo crystals or spherulites, have an effective age that's reset to zero. Packages made according to the current disclosure have improved Q10 factors and age slower versus their amorphous counterparts because of both the restricted molecular rearrangement and due to the resetting of the effective ago to zero of the amorphous sections around the pseudo crystals or spherulites. The Q10 factor for amorphous PET and APET thermoformed trays for rigid medical packaging has historically been measured at approximately 10. When manufactured according to the methods discussed in the current disclosure, the Q10 aging factor for these configurations was measurably improved, estimated to be between circa 6 to 8.5 with limited data and mathematical extrapolation.

In one aspect of the present disclosure, the properties of the resulting article are improved and decay or change overtime more slowly versus articles made in the traditional, non-oriented, amorphous methods. Such properties include the relaxation modulus, the creep modulus, the storage modulus, the reduced storage modulus, creep compliance, reduced creep compliance, loss modulus, and complex modulus. One applicable testing equipment is DMA for another embodiment.

In one aspect of the present disclosure, the properties of the resulting article are improved and decay or change overtime more slowly versus articles made in the traditional, non-oriented, amorphous methods. Such properties include the tensile modulus, tensile force, tensile elongation, tensile stress, and tensile strain.

In another aspect of the present disclosure, the multi-step process of orienting the package lessens undesirable webbing that might occur during thermoforming. Webbing occurs when a material stretches excessively during the thermoforming process. Several different factors can be involved, including excessive heat in the localized zone which facilitates excessive stretching in the localized area, allowing the rubbery film to fold on itself. In the present disclosure, if the partially-stretched film has not been optionally heat set to remove the internal stresses, the sheet can temporarily shrink and pull tight in the clamps right before and during thermoforming, thus lessening the propensity to form undesirable webbing defects.

In another aspect of the present disclosure, the multi-step process of orienting the package leads to differences in the degree of polymer chain alignment in different directions. This birefringence is quantifiable by evaluating the ratio or difference of the refractive index when measured in the film planar vs thickness directions. The significance is that this method might be used by one skilled in the art to characterize the properly oriented film or article, wherein a difference of 0.005 of the refractive indexes as measured in the planar versus thickness direction is determined to be an important threshold.

In another aspect of the present disclosure, the multi-step process of orienting the package raises the article or package's temperature stability. Partially orienting or partially stretching the substrate to form the package can mechanically induce small pseudo-crystals. These small crystallites increase the package's temperature stability such that the material's use temperature can and preferably does exceed the material's glass transition temperature. Part shrinkage is avoided or reduced when an optional heat-setting step is involved.

In one aspect of the current disclosure, traditionally manufactured PET, APET, and PETG trays, all of which maintain an amorphous morphology, have been found to fail certain PET recycle flake clumping test methods due to a high degree of agglomeration. When manufactured according to the methods discussed in the current disclosure, the PET and APET trays with small spherulites pass these test methods without agglomerations which otherwise are detrimental to the PET flake recycling process. One such test method is PET-S-08 issued by The Association of Plastic Recyclers, when the optional crystallization protocol is not performed.

The above method, its steps, and systems incorporating the method can be better understood by the following prophetic examples, which illustrate the process. Physical experiments have been performed to demonstrate this novel technology. However, such testing has not been completed, and thus, there are gaps in the data sets actually run. Further experiments are still progressing at the time of the filing of this application. To better avoid confusion, all experiments will be described as prophetic whereas partial work has been performed. Where necessary, the prophetic examples are extrapolated from actual experiments carried out; though, the inventors do not assert that the following prophetic examples themselves were carried out. The prophetic examples are offered by way of illustration of the process and are not meant to be limiting; rather, the scope is defined by the claims.

### Prophetic Examples

### Example 1

APET recycle flake is dried overnight (approximately 24 hours) in a Conair D400 desiccant dryer with −30-degree Celsius dew point at about 62. 8 degrees Celsius (145 degrees Fahrenheit). This dried flake is then extruded into a sheet on a 4.5-inch single screw, non-vented, 24:1 Crown extrusion line at an average film thickness of about 0.065 inches. A straight temperature profile of 276.7 degrees Celsius (530 degrees Fahrenheit) is used with a production rate averaging 380 pounds per hour. The extrudate is deposited onto a three-roll, water-cooled calendar stack with a downward orientation using chrome rolls with a polished surface finish of about zero microinches Ra when new. Roll temperatures are 18.3 degrees Celsius (65 degrees Fahrenheit), 65.6 degrees Celsius (150 degrees Fahrenheit), and 71.1 degrees Celsius (160 degrees Fahrenheit) from the top to bottom rolls. By this method, a set of 7 extruded samples is produced. This set of extruded samples is designated as Sample Set AA (Samples BA, CA, DA, EA, FA, GA, and HA).

Extruded APET films of Sample Set AA are then heated and stretched on a non-commercial stretching apparatus in two directions by the following sequence:
clamping the edges of the sheet (clamps about 1 inch apart at start);
heating for 15 seconds in a cal-rod element oven with a temperature setpoint of 398.9 degrees Celsius (750 degrees Fahrenheit) to reach a film surface temperature of about 96.1 degrees Celsius (205 degrees Fahrenheit);
stretching the film at a rate of about 3 inches per second; and
cooling the resulting film with forced circulation air.
   Table A identifies additional details on the stretching conditions and predicted results.

TABLE A

| | | | Film | | | | |
|---|---|---|---|---|---|---|---|
| | | Heating | Surface | | Initial | Stretch | Stretch |
| Sample | Substrate | Time | Temperature | Stretch Rate | Length | Ratio x- | Ratio y- |
| ID | Chemistry | (seconds) | (deg. C.) | (inches/second) | (Inches) | direction | direction |
| BA | APET | 15 | 96.1 | 3 | 8 | 1.0 | 1.0 |
| | flake | | | | | | |
| CA | APET | 15 | 96.1 | 3 | 8 | 1.5 | 1.5 |
| | flake | | | | | | |
| DA | APET | 15 | 96.1 | 3 | 8 | 2.0 | 2.0 |
| | flake | | | | | | |
| EA | APET | 15 | 96.1 | 3 | 8 | 2.5 | 2.5 |
| | flake | | | | | | |
| FA | APET | 15 | 96.1 | 3 | 8 | 3.0 | 3.0 |
| | flake | | | | | | |
| GA | APET | 15 | 96.1 | 3 | 8 | 3.5 | 3.5 |
| | flake | | | | | | |
| HA | APET | 15 | 96.1 | 3 | 8 | 4.0 | 4.0 |
| | flake | | | | | | |

Samples BA through HA are then thermoformed on an aluminum female mold with a cylindrical shape of a diameter 2 inches and a height of 1 inch. This is accomplished by heating the sheet to 143.3 degrees Celsius (290 degrees Fahrenheit) in an oven for various times due to the different film and sheet thicknesses then vacuum forming with plug assist with 0.150-inch clearance to the mold and subsequent air cooling from a fan (30 seconds) to turn the flat sheet into a three-dimensional article. Table B shows the various thermoforming conditions and predicted results.

TABLE B

| | | Heating | Film Surface | Vacuum | Fan Cooling | |
|---|---|---|---|---|---|---|
| Sample ID | Sample ID | Time | Temperature | Time | Time | Predicted |
| (Pre-formed) | (Post-formed) | (seconds) | (deg. C.) | (seconds) | (seconds) | Result |
| BA | IA | 66 | 143.3 | 15 | 30 | Formed |
| | | | | | | Properly |
| CA | JA | 61 | 143.3 | 15 | 30 | Formed |
| | | | | | | Properly |
| DA | KA | 57 | 143.3 | 15 | 30 | Formed |
| | | | | | | Properly |
| EA | LA | 53 | 143.3 | 15 | 30 | Formed |
| | | | | | | Properly |
| FA | MA | 49 | 143.3 | 15 | 30 | Formed |
| | | | | | | Properly |
| GA | NA | 44 | 143.3 | 15 | 30 | Almost |
| | | | | | | Formed |
| | | | | | | Properly |
| HA | OA | 40 | 143.3 | 15 | 30 | Did not Form |
| | | | | | | Properly |

Sample OA does not properly accept the thermoformed shape since precursor film HA closely represents oriented PET, commercially available today, and is known to have been stretched too far to be thermoformable.

Samples IA through OA are then heat set by positioning the article on the mold and placing them in an oven at 180 degrees Celsius for 5 minutes to make the samples shown in Table C.

TABLE C

| Sample ID | Sample ID |
|---|---|
| (Pre-heat treatment) | (Post-heat treatment) |
| IA | PA |
| JA | QA |
| KA | RA |
| LA | SA |
| MA | TA |
| NA | WA |
| OA | XA |

Samples IA through XA are then exposed to steam to mimic steam sterilization in a pressure cooker for 10 minutes at approximately 121.1 degrees Celsius (250 degrees Fahrenheit) where the saturated steam temperature is achieved by regulating the pressure to approximately 15 pounds per square inch gauge. The predicted results as outlined in Table D include the predicted visual results from a visual assessment performed to evaluate a comparison between the initial and final article shapes and to assess the color change in the article (clear/hazy/white) indicative of thermally induced crystallization with an excessive quantity of large-sized crystals (crystal sizes will follow a distribution). Further, the predicted results include predicted impact results of the samples being subjectively impacted to determine the relative level of brittleness (break or no break) as summarized in Table D:

TABLE D

| | | | Predicted |
|---|---|---|---|
| | | | Impact |
| Sample ID | Heat Set? | Predicted Visual Result | Result |
| IA | No | Shape warped and turned opaque | Brittle |
| JA | No | Shape warped and turned opaque | Brittle |
| KA | No | Shape warped and turned slightly opaque | Brittle |
| LA | No | Shape warped and turned slightly hazy | Tough |
| MA | No | Shape warped and remained clear | Tough |
| NA | No | Shape warped and remained clear | Tough |
| OA | No | Shape already warped but remained clear | Tough |
| PA | Yes | Shape did not warp but remained opaque | Brittle |
| QA | Yes | Shape did not warp but remained opaque | Brittle |
| RA | Yes | Shape did not warp but remained slightly opaque | Brittle |
| SA | Yes | Shape did not warp but remained slightly hazy | Tough |
| TA | Yes | Shape did not warp but remained clear | Tough |
| WA | Yes | Shape did not warp but remained clear | Tough |
| XA | Yes | Shape already warped but remained clear | Tough |

The predicted results of this experiment demonstrate that clear, thermoformed articles can be made from semi-crystalline PET which survives the steam sterilization process. Depending on the level of haze that is acceptable (which will differ for various customers, applications, and fitness-for-use requirements), Samples SA, TA, and WA best represent the thermal processing and environmental conditions that yield articles suitable for autoclave steam sterilization, remain relatively clear and retain most of the thermoformed article's original shape without imparting brittleness. For deep-draw thermoformed shapes, even Sample RA is suitable, where a deep draw might approximate a 7-inch deep cavity. Similarly, for narrow draw ratios, Sample WA is most suitable, where a shallow draw might approximate a 0.5-inch cavity. Sample XA is representative of commercially available oriented PET film that is not thermoformable, yet it does survive steam sterilization. In contrast, sample IA is representative of both PET clam shells used in food packaging and rigid medical packaging today that crystallizes, turns opaque white, and becomes brittle, rendering this configuration as not fit for use for autoclave steam sterilization.

### Example 2

Similar to Example 1, other semi-crystalline polymers are processed to evaluate their results. Tritan SC900 resin, as available from Eastman Chemical Company, is dried for approximately 6 hours in a Conair D400 desiccant dryer with −30 degrees Celsius dew point at 121.1 degrees Celsius (250 degrees Fahrenheit). It is a crystallized pellet. This resin is extruded into a sheet on a 4.5-inch single screw, non-vented, 24:1 Crown extrusion line at an average of about 0.065 inches thick. A reverse temperature profile of 271.1 degrees Celsius (520 degrees Fahrenheit), 298.9 degrees Celsius (570 degrees Fahrenheit), 293.3 degrees Celsius (560 degrees Fahrenheit), 287.8 degrees Celsius (550 degrees Fahrenheit), 282.2 degrees Celsius (540 degrees Fahrenheit) was used in extruder zones 1 to 5, respectively, with a production rate averaging 350 pounds per hour. The extrudate is deposited onto a three-roll, water-cooled calendar stack with downward orientation using chrome polished rolls with a polished surface finish of about zero microinches Ra when new. Roll temperatures are 21.1 degrees Celsius (70 degrees Fahrenheit), 79.4 degrees Celsius (175 degrees Fahrenheit), and 85 degrees Celsius (185 degrees Fahrenheit) from the top to bottom rolls. This set of extruded samples is designated as Sample Set AT (samples BT to HT).

Additionally, film is extruded from a 65%/35% blend by volume of PCT 8564 and PCTA 5721. Both materials are available from Eastman Chemical Company. The blend is used because it is surmised that neat PCT might thermally crystallize too quickly as a film for ease of processing with this sheet thickness and that this blend would be easier to process in subsequent experimentation. The PCT 8564 is a relatively clear, non-crystallized pellet. The PCTA 5721 is also a clear, non-crystallized pellet. The resin blend of PCT 8564 and PCTA 5721 is dried for 8 hours in a desiccant dryer with −30-degree Celsius dew point at 76.7 degrees Celsius (170 degrees Fahrenheit). This resin blend is then extruded into a sheet on a 4.5-inch single screw, non-vented, 24:1 Crown extrusion line at an average of about 0.065 inches thick. A straight temperature profile of 276.7 degrees Celsius (530 degrees Fahrenheit) is used with a production rate averaging 380 pounds per hour. The extrudate is deposited onto a three-roll, water-cooled calendar stack with downward orientation using chrome polished rolls with a polished surface finish of about zero microinches Ra when new. Roll temperatures are 21.1 degrees Celsius (70 degrees Fahrenheit), 76.7 degrees Celsius (170 degrees Fahrenheit), and 82.2 degrees Celsius (180 degrees Fahrenheit) from the top to bottom rolls. This set of samples is designated as Sample Set AC (samples BC through HC).

Extruded films of Sample Sets AT and AC are subsequently heated and stretched on a non-commercial stretching apparatus in two directions by the following sequence:
clamping the edges of the sheet (clamps about 1 inch apart at start);
heating for 15 seconds in a cal-rod element oven with a temperature setpoint of 398.9 degrees Celsius (750 degrees Fahrenheit) to reach a film surface temperature of about 115.6 degrees Celsius (240 degrees Fahrenheit) for the Tritan SC900 and a surface temperature of about 110 degrees Celsius (230 degrees Fahrenheit) for the PCT/PCTA resin blend;
stretching at a rate of about 3 inches per second; and
cooling the resulting film with forced circulation air.

The following table defines additional stretching conditions and predicted results.

TABLE E

| | | | Film | | Initial | | |
|---|---|---|---|---|---|---|---|
| | | Heating | Surface | | Stretch | Stretch | Stretch |
| Sample | Substrate | Time | Temperature | Stretch Rate | Length | Ratio x- | Ratio y- |
| ID | Chemistry | (seconds) | (deg. C.) | (inches/second) | (inches) | direction | direction |
| BT | Tritan PCTM | 15 | 115.6 | 3 | 8 | 1.0 | 1.0 |
| | SC900 | | | | | | |
| CT | Tritan PCTM | 15 | 115.6 | 3 | 8 | 1.5 | 1.5 |
| | SC900 | | | | | | |
| DT | Tritan PCTM | 15 | 115.6 | 3 | 8 | 2.0 | 2.0 |
| | SC900 | | | | | | |
| ET | Tritan PCTM | 15 | 115.6 | 3 | 8 | 2.5 | 2.5 |
| | SC900 | | | | | | |
| FT | Tritan PCTM | 15 | 115.6 | 3 | 8 | 3.0 | 3.0 |
| | SC900 | | | | | | |
| GT | Tritan PCTM | 15 | 115.6 | 3 | 8 | 3.5 | 3.5 |
| | SC900 | | | | | | |
| HT | Tritan PCTM | 15 | 115.6 | 3 | 8 | 4.0 | 4.0 |
| | SC900 | | | | | | |
| BC | 65/35 mix PCT | 15 | 115.6 | 3 | 8 | 1.0 | 1.0 |
| | 8564 + PCTA | | | | | | |
| | 5721 | | | | | | |
| CC | 65/35 mix PCT | 15 | 115.6 | 3 | 8 | 1.5 | 1.5 |
| | 8564 + PCTA | | | | | | |
| | 5721 | | | | | | |
| DC | 65/35 mix PCT | 15 | 115.6 | 3 | 8 | 2.0 | 2.0 |
| | 8564 + PCTA | | | | | | |
| | 5721 | | | | | | |
| EC | 65/35 mix PCT | 15 | 115.6 | 3 | 8 | 2.5 | 2.5 |
| | 8564 + PCTA | | | | | | |
| | 5721 | | | | | | |
| FC | 65/35 mix PCT | 15 | 115.6 | 3 | 8 | 3.0 | 3.0 |
| | 8564 + PCTA | | | | | | |
| | 5721 | | | | | | |
| GC | 65/35 mix PCT | 15 | 115.6 | 3 | 8 | 3.5 | 3.5 |
| | 8564 + PCTA | | | | | | |
| | 5721 | | | | | | |
| HA | 65/35 mix PCT | 15 | 115.6 | 3 | 8 | 4.0 | 4.0 |
| | 8564 + PCTA | | | | | | |
| | 5721 | | | | | | |

Sample Sets BT through HI and Sample Sets BC through HC are then thermoformed on an aluminum female mold with acylindrical shape of a diameter of 2 inches and a height of 1 inch. This is accomplished by heating the sheet to 162.8 and 157.2 degrees Celsius (325 and 315 degrees Fahrenheit), respectively, in an oven for various times due to changing thickness then vacuum forming with plug assist with 0.150-inch clearance to the mold and subsequent air cooling from a fan (30 seconds) to turn the flat sheet into a three-dimensional article. Table F shows the thermoforming conditions and predicted results.

TABLE F

| | | | | | Fan | |
|---|---|---|---|---|---|---|
| | | Heating | Film Surface | Vacuum | Cooling | |
| Sample ID | Sample ID | Time | Temperature | Time | Time | |
| (Pre-formed) | (Post-Formed) | (seconds) | (deg. C.) | (seconds) | (seconds) | Predicted Results |
| BT | IT | 79 | 162.8 | 15 | 30 | Formed Properly |
| CT | JT | 74 | 162.8 | 15 | 30 | Formed Properly |
| DT | KT | 70 | 162.8 | 15 | 30 | Formed Properly |
| ET | LT | 66 | 162.8 | 15 | 30 | Formed Properly |
| FT | MT | 62 | 162.8 | 15 | 30 | Formed Properly |
| GT | NT | 57 | 162.8 | 15 | 30 | Almost Formed |
| | | | | | | Properly |
| HT | OT | 53 | 162.8 | 15 | 30 | Did not Form |
| | | | | | | Properly |
| BC | IC | 74 | 162.8 | 15 | 30 | Formed Properly |
| CC | JC | 69 | 162.8 | 15 | 30 | Formed Properly |
| DC | KC | 65 | 162.8 | 15 | 30 | Formed Properly |
| EC | LC | 61 | 162.8 | 15 | 30 | Formed Properly |
| FC | MC | 57 | 162.8 | 15 | 30 | Almost Formed |
| | | | | | | Properly |
| GC | NC | 52 | 162.8 | 15 | 30 | Did not Form |
| | | | | | | Properly |
| HC | OC | 48 | 162.8 | 15 | 30 | Did not Form |
| | | | | | | Properly |

Samples NT, OT, MC, NC, and OC do not properly accept the thermoformed shape, as expected, since precursor films GT, HI, FC, GC, and HC represent oriented films that have been stretched beyond the point of being frilly thermoformable. Also, note that samples IT and IC do show a minor amount of haze even though they do form properly.

Sample Sets IT through OT and IC through OC are heat set by positioning the article on the mold and placing them in an oven at 180 degrees Celsius for 5 minutes to make the samples shown in Table G.

TABLE G

| Sample ID | Sample ID |
|---|---|
| (Pre-heat treatment) | (Post-heat treatment) |
| IT | PT |
| JT | QT |
| KT | RT |
| LT | ST |
| MT | TT |
| NT | WT |
| OT | XT |
| IC | PC |
| JC | QC |
| KC | RC |
| LC | SC |
| MC | TC |
| NC | WC |
| OC | XC |

Sample Sets IT through XT and IC through XC are exposed to steam to mimic steam sterilization in a pressure cooker for 10 minutes at approximately 121.1 degrees Celsius (250 degrees Fahrenheit) where the saturated steam temperature is achieved by regulating the pressure to approximately 15 pounds per square inch gauge. The predicted results as outlined in Table H include predicted visual results from a visual assessment performed to evaluate a comparison between the initial and final article shapes and to assess the color change in the article (clear/hazy/white) indicative of thermally induced crystallization. Further, the predicted results include predicted impact results of the samples being subjectively impacted to determine the relative level of brittleness (break or no break) as summarized in Table H.

TABLE H

| | | | Impact |
|---|---|---|---|
| Sample ID | Heat Set | Visual Result | Result |
| IT | No | Shape warped and turned opaque | Brittle |
| JT | No | Shape warped and turned opaque | Brittle |
| KT | No | Shape warped and turned slightly opaque | Brittle |
| LT | No | Shape warped and turned slightly hazy | Tough |
| MT | No | Shape warped and remained clear | Tough |
| NT | No | Shape slightly warped but remained clear | Tough |
| OT | No | Shape already warped but remained clear | Tough |
| PT | Yes | Shape did not warp but remained opaque | Brittle |
| QT | Yes | Shape did not warp but remained opaque | Brittle |
| RT | Yes | Shape did not warp but remained slightly opaque | Brittle |
| ST | Yes | Shape did not warp but remained slightly hazy | Tough |
| TT | Yes | Shape did not warp but remained clear | Tough |
| WT | Yes | Shape slightly warped but remained clear | Tough |
| XT | Yes | Shape already warped but remained clear | Tough |
| IC | No | Shape warped and turned opaque | Brittle |
| JC | No | Shape warped and turned opaque | Brittle |
| KC | No | Shape warped and turned slightly opaque | Brittle |
| LC | No | Shape warped and turned slightly hazy | Tough |
| MC | No | Shape warped and remained clear | Tough |
| NC | No | Shape already warped but remained clear | Tough |
| OC | No | Shape already warped but remained clear | Tough |
| PC | Yes | Shape did not warp but remained opaque | Brittle |
| QC | Yes | Shape did not warp but remained opaque | Brittle |
| RC | Yes | Shape did not warp but remained slightly opaque | Brittle |
| SC | Yes | Shape did not warp but remained slightly hazy | Tough |
| TC | Yes | Shape did not warp but remained clear | Tough |
| WC | Yes | Shape already warped but remained clear | Tough |
| XC | Yes | Shape already warped but remained clear | Tough |

The results of this experiment demonstrate that thermoformed articles can be made from semi-crystalline blends of PCT 8564 and PCTA 5721 and from Tritan SC900 which survive the steam sterilization process. Depending on the level of haze that is acceptable (which will differ for various customers, applications, and fitness-for-use requirements), Sample Sets ST and TT, and SC represents the thermal processing and environments that yield articles suitable for autoclave steam sterilization and remain relatively clear and retain most of the thermoformed article's original shape without imparting brittleness. Samples XT and SC are representative of oriented film that is not thermoformable yet did survive steam sterilization as expected. In contrast, samples PT and PC are representative of thermoformable products that crystallize, turn opaque white, and become brittle, rendering these configurations not fit for use for steam sterilization.

### Example 3 (Comparative)

Eastar 6763 PETG from Eastman Chemical Company is the grade of copolyester that is most often specified for rigid medical packaging. A somewhat similar but non-medical grade with wider quality specification, PETG Copolyester 7870, also available at Eastman Chemical, is dried for 6 hours in a Conair D400 desiccant dryer with −30 degrees Celsius dew point at 62.8 degrees Celsius (145 degrees Fahrenheit). This dried resin is then extruded into a sheet on a 4.5-inch single screw, non-vented, 24:1 Crown extrusion line at an average of about 0.065 inches thick. A straight temperature profile of 248.9 degrees Celsius (480 degrees Fahrenheit) is used with a production rate averaging 350 pounds per hour. The extrudate is deposited onto a three-roll, water-cooled calendar stack, with downward orientation, using chrome polished rolls with a polished surface finish of about zero microinches Ra when new. Roll temperatures are 21.1 degrees Celsius (70 degrees Fahrenheit), 65.6 degrees (150 degrees Fahrenheit) and 71.1 degrees Celsius (160 degrees Fahrenheit) from the top to bottom rolls. This set of samples will be designated as Sample Set AG.

Extruded PETG film Sample Set AG is subsequently heated and stretched on a non-commercial stretching apparatus in two directions by the following sequence:
clamping the edges of the sheet (clamps about 1 inch apart at start);
heating for 15 seconds in a cal-rod element oven with a temperature setpoint of 398.9 degrees Celsius (750 degrees Fahrenheit) to reach a film surface temperature of about 96.1 degrees Celsius (205 degrees Fahrenheit);
stretching the film at a rate of about 3 inches per second; and
cooling the resulting film with forced circulation air.
   Table I shows the stretching conditions and predicted results.

TABLE I

| | | | Film | | | | |
|---|---|---|---|---|---|---|---|
| | | Heating | Surface | | Initial | Stretch | Stretch |
| Sample | Substrate | Time | Temperature | Stretch Rate | Length | Ratio x- | Ratio y- |
| ID | Chemistry | (Seconds) | (Deg. C.) | (inches/second) | (inches) | direction | direction |
| BG | PETG 7870 | 15 | 96.1 | 3 | 8 | 1.0 | 1.0 |
| CG | PETG 7870 | 15 | 96.1 | 3 | 8 | 1.5 | 1.5 |
| DG | PETG 7870 | 15 | 96.1 | 3 | 8 | 2.0 | 2.0 |
| EG | PETG 7870 | 15 | 96.1 | 3 | 8 | 2.5 | 2.5 |
| FG | PETG 7870 | 15 | 96.1 | 3 | 8 | 3.0 | 3.0 |
| GG | PETG 7870 | 15 | 96.1 | 3 | 8 | 3.5 | 3.5 |
| HG | PETG 7870 | 15 | 96.1 | 3 | 8 | 4.0 | 4.0 |

Sample Sets BG through HG are then thermoformed on an aluminum female mold with a cylindrical shape of a diameter of 2 inches and a height of 1 inch. This is accomplished by heating the sheet to 143.3 Degrees Celsius (290 degrees Fahrenheit) in an oven for various times due to the different film and sheet thicknesses then vacuum forming with subsequent air cooling from a fan (30 seconds) to turn the flat sheet into a three-dimensional article. Table J shows the thermoforming conditions and predicted results:

TABLE J

| | | Heating | Film Surface | Vacuum | Fan Cooling | |
|---|---|---|---|---|---|---|
| Sample ID | Sample ID | Time | Temperature | Time | Time | Predicted |
| (Pre-formed) | (Post-formed) | (seconds) | (deg. C.) | (seconds) | (seconds) | Result |
| BG | IG | 66 | 143.3 | 15 | 30 | Formed |
| | | | | | | Properly |
| CG | JG | 61 | 143.3 | 15 | 30 | Formed |
| | | | | | | Properly |
| DG | KG | 57 | 143.3 | 15 | 30 | Formed |
| | | | | | | Properly |
| EG | LG | 53 | 143.3 | 15 | 30 | Formed |
| | | | | | | Properly |
| FG | MG | 49 | 143.3 | 15 | 30 | Formed |
| | | | | | | Properly |
| GG | NG | 44 | 143.3 | 15 | 30 | Formed |
| | | | | | | Properly |
| HG | OG | 40 | 143.3 | 15 | 30 | Formed |
| | | | | | | Properly |

All samples properly accept the thermoform shape with no visible haze.

Sample Sets IG through OG are then heat set by positioning the article on the mold and placing them in an oven at 180 degrees Celsius for 5 minutes to make the samples shown in Table K.

TABLE K

| Sample ID | Sample ID |
|---|---|
| (Pre-heat treatment) | (Post-heat treatment) |
| IG | PG |
| JG | QG |
| KG | RG |
| LG | SG |
| MG | TG |
| NG | WG |
| OG | XG |

The result is that all samples (samples IG through XG) adhere to the mold and cannot be heat set. Samples are re-run with silicone mold release spray and a dusting of talcum powder to better prevent sticking.

Sample IG through XG are exposed to steam to mimic steam sterilization in a pressure cooker for 10 minutes at approximately 121.1 degrees Celsius (250 degrees Fahrenheit) where the saturated steam temperature is achieved by regulating the pressure to approximately 15 pounds per square inch gauge. The predicted results as outlined in Table L include predicted visual results from a visual assessment performed to evaluate a comparison between the initial and final article shapes and to assess the color change in the article (clear/hazy/white) indicative of thermally induced crystallization. Further, where possible, the predicted results include predicted impact results of the samples being subjectively impacted to determine the relative level of brittleness (break or no break) as summarized in Table L.

TABLE L

| | | | Predicted |
|---|---|---|---|
| | | | Impact |
| Sample ID | Heat Set? | Predicted Visual Result | Result |
| IG | No | Shape warped but remained clear | Not Tested |
| JG | No | Shape warped but remained clear | Not Tested |
| KG | No | Shape warped but remained clear | Not Tested |
| LG | No | Shape warped but remained clear | Not Tested |
| MG | No | Shape warped and remained clear | Not Tested |
| NG | No | Shape warped but remained clear | Not Tested |
| OG | No | Shape warped but remained clear | Not Tested |
| PG | Yes | Shape warped but remained clear | Not Tested |
| QG | Yes | Shape warped but remained clear | Not Tested |
| RG | Yes | Shape warped but remained clear | Not Tested |
| SG | Yes | Shape warped but remained clear | Not Tested |
| TG | Yes | Shape warped but remained clear | Not Tested |
| WG | Yes | Shape warped but remained clear | Not Tested |
| XG | Yes | Shape warped but remained clear | Not Tested |

This experiment demonstrates that thermoformed articles can be made from PETG do not survive the steam sterilization process. While the samples do accept orientation, an amorphous shrink film is made which is devoid of the high-temperature stabilizing spherulites. Clear, three-dimensional articles or packages made from PETG are therefore not fit for use for steam sterilization, as expected.

### Example 4

A 50/50 dry pellet blend of APET 9921M resin available from Alpek and Homopolymer CB PET resin available from FENC (Far Eastern New Century) is dried overnight (approximately 12 hours) in a Conair D400 desiccant dryer with −30-degree Celsius dew point at 137.8 degrees Celsius (280 degrees Fahrenheit). This dry resin blend is then extruded into a sheet on a 4.5-inch single screw, non-vented, 24:1 Crown extrusion line at an average film thickness of about 0.065 inches. A straight temperature profile of 276.7 degrees Celsius (530 degrees Fahrenheit) is used with a production rate averaging 380 pounds per hour. The extrudate is deposited onto a three-roll, water-cooled calendar stack with a downward orientation using chrome rolls with a polished surface finish of about zero microinches Ra when new. Roll temperatures are 18.3 degrees Celsius (65 degrees Fahrenheit), 65.6 degrees Celsius (150 degrees Fahrenheit), and 71.1 degrees Celsius (160 degrees Fahrenheit) from the top to bottom rolls. This set of extruded samples is then stretched on a Marshall & Williams MDO stretching line in the machine direction at 1.65 times its original length with these conditions. This roll stock is then fed into a Marshall & Williams TDO tenter frame to stretch the film 1.65 times its original width in a transverse or cross direction to make a bi-axial stretched film. These conditions are used. The partially stretched biax film is then thermoformed in a female mold with a plug assist with a 0.2-inch clearance at a surface sheet temperature of 132.2 degrees Celsius (270 degrees Fahrenheit). Vacuum is used to finish pulling the sheet into place to make a finished part. This part is heat set in the same mold at 160 degrees Celsius for 2 minutes. This part survives a boiling water test at 100 degrees Celsius without shrinkage or whitening.

### Example 5

APET 9921M resin available from Alpek is dried overnight (approximately 12 hours) in a Conair D400 desiccant dryer with −30-degree Celsius dew point at 137 degrees Celsius (280 degrees Fahrenheit). The dry resin is then extruded into a sheet on a 4.5-inch single screw, non-vented, 24:1 Crown extrusion line at an average film thickness of about 0.065 inches. A straight temperature profile of 276.7 degrees Celsius (530 degrees Fahrenheit) is used with a production rate averaging 380 pounds per hour. The extrudate is deposited onto a three-roll, water-cooled calendar stack with a downward orientation using chrome rolls with a polished surface finish of about zero microinches Ra when new. Roll temperatures are 18.3 degrees Celsius (65 degrees Fahrenheit), 65.6 degrees Celsius (150 degrees Fahrenheit), and 71.1 degrees Celsius (160 degrees Fahrenheit) from the top to bottom rolls. This set of extruded samples is then stretched on a Marshall & Williams MDO stretching line in the machine direction at 1.9 times its original length at 90.6 degrees Celsius (195 degrees Fahrenheit) and an initial line speed of 5 feet per minute. This roll stock is then fed into a Marshall & Williams TDO tenter frame to stretch the film 1.9 times its original width in a transverse or cross direction to make a bi-axial stretched film. The initial roll speed was 5 feet per minute and oven temperatures of 82.2, 101.7, and 107.2 degrees Celsius (180, 215 and 225 degrees Fahrenheit) in oven zones 1, 2, and 3, respectively. The partially stretched biax film is then thermoformed in a female mold with a plug assist with a 0.2-inch clearance at a surface sheet temperature of 140.6 degrees Celsius (285 degrees Fahrenheit). Vacuum is used to finish pulling the sheet into place to make a finished part. This part is heat set in the same mold at 200 degrees Celsius for 7 minutes. This part survives autoclave steam sterilization for 10 minutes without a significant amount of shrinkage or whitening.

### Example 6 (Comparative)

A 50/50 dry pellet blend of APET 9921M resin available from Alpek and Homopolymer CB PET resin available from FENC (Far Eastern New Century) is dried overnight (approximately 12 hours) in a Conair D400 desiccant dryer with −30-degree Celsius dew point at 137.8 degrees Celsius (280 degrees Fahrenheit). This dry resin blend is then extruded into a sheet on a 4.5-inch single screw, non-vented, 24:1 Crown extrusion line at an average film thickness of about 0.065 inches. A straight temperature profile of 276.7 degrees Celsius (530 degrees Fahrenheit) is used with a production rate averaging 380 pounds per hour. The extrudate is deposited onto a three-roll, water-cooled calendar stack with a downward orientation using chrome rolls with a polished surface finish of about zero microinches Ra when new. Roll temperatures are 18.3 degrees Celsius (65 degrees Fahrenheit), 65.6 degrees Celsius (150 degrees Fahrenheit), and 71.1 degrees Celsius (160 degrees Fahrenheit) from the top to bottom rolls. This set of extruded samples is then stretched on a Marshall & Williams MDO stretching line in the machine direction at 1.3 times its original length at 90.6 degrees Celsius (195 degrees Fahrenheit) and an initial line speed of 5 feet per minute. This roll stock is then fed into a Marshall & Williams TDO tenter frame to stretch the film 1.3 times its original width in a transverse or cross direction to make bi-axial stretched film. The initial roll speed was 5 feet per minute and oven temperatures of 82.2, 101.7 (180, 215 and 225 degrees Fahrenheit) in oven zones 1, 2, and 3, respectively. The partially stretched biax film is then thermoformed in a female mold with a plug assist with a 0.2-inch clearance at a surface sheet temperature of 132.2 degrees Celsius (270 degrees Fahrenheit). Vacuum is used to finish pulling the sheet into place to make a finished part. This part is heat set in the same mold at 160 degrees Celsius for 2 minutes. This part showed excessive haze and was no longer clear after the heat setting. However, it does survive a boiling water test at 100 degrees Celsius without shrinkage.

### Example 7 (Comparative)

A 50/50 dry pellet blend of APET 9921M resin available from Alpek and Homopolymer CB PET resin available from FENC (Far Eastern New Century) is dried overnight (approximately 12 hours) in a Conair D400 desiccant dryer with −30-degree Celsius dew point at 137.8 degrees Celsius (280 degrees Fahrenheit). This dry resin blend is then extruded into sheet on a 4.5-inch single screw, non-vented, 24:1 Crown extrusion line at an average film thickness of about 0.065 inches. A straight temperature profile of 276.7 degrees Celsius (530 degrees Fahrenheit) is used with a production rate averaging 380 pounds per hour. The extrudate is deposited onto a three-roll, water-cooled calendar stack with downward orientation using chrome rolls with a polished surface finish of about zero microinches Ra when new. Roll temperatures are 18.3 degrees Celsius (65 degrees Fahrenheit), 65.6 degrees Celsius (150 degrees Fahrenheit) and 71.1 degrees Celsius (160 degrees Fahrenheit) from the top to bottom rolls. This set of extruded samples is then stretched on a Marshall & Williams MDO stretching line in the machine direction at 4 times its original length at 90.5 degrees Celsius (195 degrees Fahrenheit) and an initial line speed of 5 feet per minute. This roll stock is then fed into a Marshall & Williams TDO tenter frame to stretch the film 4 times its original width in a transverse or cross direction to make bi-axial stretched film. The initial roll speed was 5 feet per minute and oven temperatures of 82.2, 101.7 and 107.2 degrees Celsius (180, 215 and 225 degrees Fahrenheit) in oven zones 1, 2 and 3, respectively. The partially stretched biax film is then thermoformed in a female mold with plug assist with a 0.2-inch clearance at a surface sheet temperature of 132.2 degrees Celsius (270 degrees Fahrenheit). The film has insufficient elongation remaining so a part cannot be made, and no further testing is performed.

### Example 8

From Example 1, additional pieces of stretched film (but not thermoformed)labeled as Samples BA through HA are then thermoformed on an aluminum female mold with a square shape of 5 inches long on one side, 5 inches long on the second side and a depth of 5 inches. This is accomplished by heating the sheet to 143.3 degrees Celsius (290 degrees Fahrenheit) in an oven for various times due to the different film and sheet thicknesses then vacuum forming with plug assist with 0.150-inch clearance to the mold and subsequent air cooling from a fan (30 seconds) to turn the flat sheet into a three-dimensional article. Table M shows the various thermoforming conditions and predicted results.

TABLE M

| | | Heating | Film Surface | Vacuum | Fan Cooling | |
|---|---|---|---|---|---|---|
| Sample ID | Sample ID | Time | Temperature | Time | Time | Predicted |
| (Pre-formed) | (Post-formed) | (seconds) | (deg. C.) | (seconds) | (seconds) | Result |
| BA | IA2 | 66 | 143.3 | 15 | 30 | Formed |
| | | | | | | Properly |
| CA | JA2 | 61 | 143.3 | 15 | 30 | Formed |
| | | | | | | Properly |
| DA | KA2 | 57 | 143.3 | 15 | 30 | Formed |
| | | | | | | Properly |
| EA | LA2 | 53 | 143.3 | 15 | 30 | Formed |
| | | | | | | Properly |
| FA | MA2 | 49 | 143.3 | 15 | 30 | Almost |
| | | | | | | Formed |
| | | | | | | Properly |
| GA | NA2 | 44 | 143.3 | 15 | 30 | Did not Form |
| | | | | | | Properly |
| HA | OA2 | 40 | 143.3 | 15 | 30 | Did not Form |
| | | | | | | Properly |

Samples OA2 and NA2 do not properly accept the thermoformed shape since precursor films HA and GA closely represent oriented PET, commercially available today, and is known to have been stretched too far to be thermoformable. Compared to Example 1, since this mold is deeper (5 inches deep here versus 1 inch deep in Example 1), note that less stretching of films BA through HA are needed for properly formed parts. In other words, IA through OA and IA2 through OA2 have been stretched by the various processes to approximately the same extent, but properly formed parts in this example occurred at lower stretch ratios during forming since a deep, 5-inch draw stretches the film more in this step compared to Example 1.

Samples IA2 through OA2 are then heat set by positioning the article on the mold and placing them in an oven at 180 degrees Celsius for 5 minutes to make the samples shown in Table N.

TABLE N

| Sample ID | Sample ID |
|---|---|
| (Pre-heat treatment) | (Post-heat treatment) |
| IA2 | PA2 |
| JA2 | QA2 |
| KA2 | RA2 |
| LA2 | SA2 |
| MA2 | TA2 |
| NA2 | WA2 |
| OA2 | XA2 |

Samples IA2 through XA2 are then exposed to steam to mimic steam sterilization in a pressure cooker for 10 minutes at approximately 121.1 degrees Celsius (250 degrees Fahrenheit) where the saturated steam temperature is achieved by regulating the pressure to approximately 15 pounds per square inch gauge. The predicted results as outlined Table O include the predicted visual results from a visual assessment performed to evaluate a comparison between the initial and final article shapes and to assess the color change in the article (clear/hazy/white) indicative of thermally induced crystallization with an excessive quantity of large-sized crystals (crystal sizes will follow a distribution). Further, the predicted results include predicted impact results of the samples being subjectively impacted to determine the relative level of brittleness (break or no break) as summarized in Table O.

TABLE O

| | | | Predicted |
|---|---|---|---|
| | | | Impact |
| Sample ID | Heat Set? | Predicted Visual Result | Result |
| IA2 | No | Shape warped and turned opaque | Brittle |
| JA2 | No | Shape warped and turned slightly opaque | Brittle |
| KA2 | No | Shape warped and turned slightly hazy | Brittle |
| LA2 | No | Shape warped and remained clear | Tough |
| MA2 | No | Shape warped and remained clear | Tough |
| NA2 | No | Shape already warped but remained clear | Tough |
| OA2 | No | Shape already warped but remained clear | Tough |
| PA2 | Yes | Shape did not warp but remained opaque | Brittle |
| QA2 | Yes | Shape did not warp but remained slightly opaque | Brittle |
| RA2 | Yes | Shape did not warp but remained slightly hazy | Brittle |
| SA2 | Yes | Shape did not warp but remained clear | Tough |
| TA2 | Yes | Shape did not warp but remained clear | Tough |
| WA2 | Yes | Shape already warped but remained clear | Tough |
| XA2 | Yes | Shape already warped but remained clear | Tough |

The predicted results of this experiment demonstrate that clear, thermoformed articles can be made from semi-crystalline PET which survive the steam sterilization process. Depending on the level of haze that is acceptable (which will differ for various customers, applications, and fitness for use requirements), Samples RA2, SA2 and TA2 best represent the thermal processing and environmental conditions that yield articles suitable for autoclave steam sterilization, remain relatively clear and retain most of the thermoformed article's original shape without imparting brittleness.

The method and compositions of this disclosure can be further understood by the following numbered embodiments.

Embodiment 1: A process for producing a clear, three-dimensional article, said process comprising:
(a) heating a crystalline or semi-crystalline thermoplastic film or sheet made of a thermoplastic polymer and having an average thickness of at least 0.010 inches but not more than 0.500 inches;
(b) stretching the film or sheet between 1.2 to 7 times its original dimension;
(c) forming the three-dimensional article during or after the stretching process;
(d) optionally heat-setting said article,
wherein the resulting three-dimensional article can withstand long-term exposure to an elevated thermal climate that is at least equal to the glass transition temperature of the thermoplastic polymer, up to the heat-setting temperature, but not to exceed the melt temperature of the thermoplastic polymer, wherein the article, post thermal climate exposure, does not exhibit a significant degree of warpage and is without a significant degree of visual haze generation in a majority of the article.

Embodiment 2: A process for producing a clear, three-dimensional article, said process comprising:
(a) heating a crystalline or semi-crystalline thermoplastic film or sheet having an average thickness of at least 0.015 inches but not more than 0.190 inches;
(b) stretching the film or sheet between 1.5 to 3.5 times its original dimension;
(c) forming the three-dimensional article during or after the stretching process;
(d) optionally heat-setting said article,
wherein the resulting three-dimensional article can withstand long-term exposure to steam sterilization between 115 and 170 degrees Celsius wherein the article, post steam sterilization, exhibits less than 10% shrinkage and maintains an average haze of less than 8% (as measured by ASTM D1003) or a light transmission of greater than 75% (as measured by ASTM D1003) when measured in 10 locations equidistant throughout the article.

Embodiment 3: A clear, three-dimensional article, made by a process comprising: (a) heating a crystalline or semi-crystalline thermoplastic film or sheet having an average thickness of at least 0.010 inches but not more than 0.500 inches;
(b) stretching the film or sheet between 1.2 to 7 times its original dimension;
(c) forming a three-dimensional article during or after the stretching process; and
(d) optionally heat-setting said article wherein the resulting three-dimensional article can withstand long-term exposure to an elevated thermal climate that is at least equal to the material's glass transition temperature, up to the heat-setting temperature, but not to exceed the material's melt temperature, wherein the article, post thermal climate exposure, exhibits less than 10% shrinkage.

Embodiment 4: The process or article of any of Embodiments 1 to 3, wherein the elevated thermal climate is achieved via steam sterilization where the steam is initially applied to the external surface of the clear, three-dimensional article.

Embodiment 5: The process or article of Embodiments 1 to 4, wherein the elevated thermal climate is achieved via steam sterilization that occurs from 215 to 430 degrees Fahrenheit (101 to 221 degrees Celsius) for at least 20 seconds.

Embodiment 6: The process or article of any preceding Embodiment, wherein the film or sheet is made and partially stretched with an in-line process, such as machine-direction orientation (MDO) stretching, transverse-direction orientation (TDO) stretching, stretched via a diagonal stretching process, stretched bi-axially (both directions, simultaneously as an option), or stretched via blown film extrusion.

Embodiment 7: The process or article of any of Embodiments 1 to 5, wherein the film or sheet is partially stretched with an off-line, optionally batch-wise process, post-extrusion process using a tenter frame or a thermoforming machine with the capability to pre-stretch film or sheet in the planar direction of the film or sheet prior to thermoforming in the z direction to make a three-dimensional article.

Embodiment 8: The process or article of any preceding Embodiment, wherein the partially-stretched film or sheet is turned into a three-dimensional article via vacuum thermoforming with optional plug assist, drape forming, pressure forming, matched-mold pressing or membrane pressing with optionally hot or cold bladder hydraulics as is often used in making membrane switches.

Embodiment 9: The process of any preceding Embodiment, wherein the clear, three-dimensional article is heat set by placing or keeping the article on the mold, during forming or optionally in a separate step, and subjecting said article to a temperature between the glass transition temperature and the melt temperature of the article for at least 5 seconds.

Embodiment 10: The process or article of any preceding Embodiment, wherein there is no heating setting step between step (b) stretching the film and step (c) forming a three-dimensional article to avoid thermally induced crystallization and/or as a thermoforming enhancement to reduce webbing defects.

Embodiment 11: The process or article of any preceding Embodiment, wherein the stretching in step (b) is performed in a bi-axial or an x-direction and y-direction planar manner.

Embodiment 12: The process or article of any preceding Embodiment, wherein the three-dimensional article has a crystallinity percentage of less than 30%.

Embodiment 13: The process or article of any preceding Embodiment, wherein the forming in step (c) utilizes a plug assist, matched mold, hydraulic bladder, or similar method to force the stretch sheet into or around the mold to form a proper shape.

Embodiment 14: A clear, three-dimensional article comprising a crystalline or semi-crystalline thermoplastic polymer with a crystallinity of at least 8% with a crystal size below 400 nanometers, haze less than 10% and light transmission greater than 70% that can withstand long-term exposure to an elevated thermal climate that is at least equal to the glass transition temperature of the polymer but less than the melt temperature of the polymer, wherein the article, post elevated thermal exposure, exhibits less than 10% shrinkage.

Embodiment 15: The article of Embodiment 14, wherein the elevated thermal climate is achieved via steam sterilization where the steam is initially applied to the external surface of the clear, three-dimensional article.

Embodiment 16: The article of either Embodiment 14 or 15, where the crystallinity of the article is less than 30%.

Embodiment 17: The article of any of Embodiments 3 to 16, wherein the clear, three-dimensional article has a measured haze value of less than 10% as measured by ASTM D1003.

Embodiment 18: The article of any of Embodiments 3 to 17, wherein the clear, three-dimensional article has a measured light transmission of greater than 70% as measured by ASTM D1003.

Embodiment 19: The article of any of Embodiments 3 to 18, wherein the crystalline or semi-crystalline thermoplastic has a percentage of crystallinity of at least 8% as measured by DSC, SALLS, or XRD.

Embodiment 20: The article of any of Embodiments 3 to 19, wherein the clear, three-dimensional article has a birefringence or refractive index difference of greater than 0.005 when measured along the plane of the film or sheet in the stretched direction versus the non-stretched direction.

Embodiment 21: The article of any of Embodiments 3 to 19, wherein the clear, three-dimensional article has a birefringence or refractive index difference of greater than 0.005 when measured along the plane of the film or sheet in the stretched direction versus the measurement taken through the film or sheet thickness direction.

Embodiment 22: The article of any of Embodiments 3 to 21, wherein the clear, thermoplastic, crystalline or semi-crystalline film or sheet comprises aromatic or aliphatic versions of polyesters, polyamides, polyurethanes, polystyrene, polypropylene, cyclic olefin polymers and copolymers (COP/COC), polyarylates (PAR), Polycaprolactone (PCL), Polylactic acid (PLA), and copolymers, combinations, and blends thereof.

Embodiment 23: The article of Embodiment 22, wherein the film is crystalline or semi-crystalline polyester and the polyester can be either aromatic or aliphatic in nature and comprise, but are not limited to, polyethylene terephthalate (PET), amorphous polyethylene terephthalate (APET), glycol-modified polyethylene terephthalate (PETG), acid-modified polyethylene terephthalate (PETA), Polycyclohexylenedimethylene terephthalate (PCT), glycol-modified Polycyclohexylenedimethylene terephthalate (PCTG), acid-modified Polycyclohexylenedimethylene terephthalate (PCTA), polyethylene naphthalate (PEN), polyethylene furanoate (PEF), Polytrimethylene terephthalate (PTT), polybutylene terephthalate (PBT), Polybutylene Naphthalate (PBN), Polybutylene adipate-co-terephthalate (PBAT), Polytretramethylenecyclobutylene terephthalate (PCTM), Polycyclohexanedimethyl cyclohexanedicarboxylate (PCCD), Polycyclohexylene dimethylene cyclohexanedicarboxylate (PCCE, copolyester ether elastomer), Polycyclohexanedimethylene-co-isosorbide terephthalate, and copolymers, isomers and blends thereof; and optionally where the polyester or PET is from a recycled source.

Embodiment 24: The article of Embodiment 23, wherein the primary monomers and secondary diol or diacid comonomers and additional comonomers, including multi-functional branching monomers, can be either aromatic or aliphatic in nature and comprise the following moieties: propylene glycol, 1,3-propanediol, 2,4-dimethyl-2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, 1,4-cyclohexanedimethanol, p-xylylene glycol, polyethylene glycol, diethylene glycol, polytetramethylene glycol, 2,2,4,4-tetramethyl-1,3-cyclobutanediol, phthalic acid, isophthalic acid, furandicarboxylic acid, 1,4-1,5-, 2,6-, and 2,7-naphthalenedicarboxylic acid, 1,3-, 1,4-cyclohexanedicarboxylic acid (which may be cis, trans or a mixture thereof), cyclohexanediacetic acid, trans-4,4′-stilbenedicarboxylic acid, 4,4′-oxydibenzoic acid, 3,3′- and 4,4′-biphenyldicarboxylic acids, malonic acid, succinic acid, glutaric acid, adipic acid, azelaic acid, sebacic acid, suberic acid, pimelic acid, nonane, decane, dodecanedicarboxylic acids. cyclohexane dimethanol, butanediol, propanediol, neopentyl glycol, spiroglycol, isosorbide, 2, 2, 4, 4-tetramethyl-1,3-cyclobutanediol, diethylene glycol, ethylene glycol, bisphenol A (BPA), pentaerythritol and polyethylene glycol (PEG), and combinations thereof.

Embodiment 25: The article of any of Embodiments 3 to 20, wherein the clear, three-dimensional article is made from a hygroscopic polymeric material with a minimum moisture regain of at least 0.05%.

Embodiment 26: The article of any of Embodiments 3 to 25, wherein the clarity of the three-dimensional article has been temporarily or permanently obscured by the addition of a matte or engineered surface texture to one or both sides of an otherwise clear polymeric film or sheet.

Embodiment 27: The article of any of Embodiments 3 to 26, wherein the clear, three-dimensional article is at least as tough or strong as a similar article made from an amorphous, thermoplastic film or sheet with less than 8% crystallinity when tested according to Instrumented Impact Test ASTM D3763, the Bruceton staircase impact method, Elmendorf Tear Resistance testing, ASTM D1922 or Trouser Tear Resistance @200 mm/min, ISO 6383-1).

Embodiment 28: The article of any of Embodiments 3 to 27, wherein the clear, three-dimensional article possesses a physical aging Q10 factor that is numerically lower than that measured from a similar article made from an amorphous, thermoplastic film or sheet with less than 8% crystallinity when tested according to ASTM F1980-02.

Embodiment 29: The article of any of Embodiments 3 to 28, wherein the heat-setting process reduces the article shrinkage to less than 15% of its original dimension post thermal climate exposure when measured by the change in volume via a liquid fill before versus after processing.

Embodiment 30: The article of any of Embodiments 3 to 29, wherein the chemical resistance of the package is improved compared to the amorphous, non-oriented version of the package when tested according to ASTM D543.

Embodiment 31: The article of either Embodiment 3 or Embodiment 14, wherein the physical age of the article is essentially zero or unaged when the elevated thermal climate is higher than the glass transition temperature of the amorphous regions interlaced between the small spherulites.

Embodiment 32: The article of Embodiments 3, 14, or 31, wherein the sterilization process is steam sterilization.

Embodiment 33: The article of Embodiments 3, 14, or 31, wherein the sterilization process is ethylene oxide, gamma, e-beam, or chemically-activated sterilization.

Embodiment 34: The article of any of Embodiments 3 to 33, wherein recycled flake ground from the article passes PET flake clumping tests, including certain protocols as defined in test method PET-S-08 issued by The Association of Plastic Recyclers.

Embodiment 35: The process or article of any of Embodiments 1 to 34, wherein the physical age of the article is essentially zero or unaged when the elevated thermal climate is higher than the glass transition temperature of the amorphous regions interlaced between the small spherulites.

Embodiment 36: The process of any of Embodiments 1 to 13, wherein the sterilization process is steam sterilization.

Embodiment 37: The process of any of Embodiments 1 to 13, wherein the sterilization process is ethylene oxide, gamma, e-beam, or chemically-activated sterilization.

Embodiment 38: A device comprising:
a plurality of grippers configured to attach around the periphery of a thermoplastic sheet; wherein at least a portion of the grippers are mobile so as to be outwardly movable to stretch the thermoplastic sheet; and
at least one heating element in relation to the grippers so as to be configured to heat the thermoplastic sheet during stretching.

Embodiment 39: The device of Embodiment 38, wherein the device further comprises a mold configured to receive the thermoplastic sheet from the grippers and thermoform the sheet and wherein the heating element is configured to heat the sheet during the thermoforming.

Embodiment 40: The device of either Embodiment 38 or 39, wherein the grippers are configured to be moveable so as to move upward or downward over a mold, or optionally where the mold is moveable to be positioned with the grippers.

Embodiment 41: The device of any of Embodiments 38 to 40, wherein the grippers form neighboring pairs around the periphery of the thermoplastic sheet and there is a space between the neighboring pairs grippers so as to avoid shielding of the thermoplastic sheet and thereby allowing the thermoplastic between the grippers to be heated by the thermoforming oven.

Embodiment 42: The device of Embodiments 38 to 41, wherein there is a first heating element for heating the thermoplastic sheet while in the grippers and before being received by the mold, and a second heating element to heat the thermoplastic sheet after being received by the mold.

Embodiment 43: The device of any of Embodiments 38 to 42, wherein the device is controlled by controller and wherein the controller is configured such that the stretching and thermoforming occur sequentially or optionally simultaneously.

Embodiment 44: The device of Embodiment 43, wherein the controller is configured so that the device performs two stages of heating with an intermediate stretching step.

Embodiment 45: The device of either Embodiment 43 or 44, wherein the controller correlates between measured force, normalized for sheet type and thickness, to calculate the degree of pre-stretching that may be present in the thermoplastic sheet prior to stretching the thermoplastic sheet with the grippers.

Embodiment 46: The device of any of Embodiments 38 to 45, wherein the grippers stretch the thermoplastic sheet in only one direction.

Embodiment 47: The device of any of Embodiments 38 to 44, wherein the grippers stretch the thermoplastic sheet in two orthogonal directions.

Embodiments 48: The device of Embodiment 47, wherein the device is configured for the grippers to stretch the thermoplastic sheet in the two orthogonal directions simultaneously.

Embodiment 49: The device of Embodiment 47, wherein the device is configured for the grippers to sequentially stretch the thermoplastic sheet such that stretching occurs first in a first of the orthogonal directions and then in a second of the orthogonal directions.

Embodiment 50: The device of any of Embodiments 38 to 49, wherein the grippers are capable of retracting or moving by different, graduated lengths independently.

Embodiment 51: The device of any of Embodiments 38 to 50, wherein the grippers are equipped with tensiometers configured to measure and control stretch force applied to the thermoplastic sheet, optionally independently at each gripper.

Embodiment 52: The device of any of Embodiments 38 to 51, wherein the grippers are configured to move outwardly at different rates.

Embodiment 53: The device of any of Embodiments 38 to 52, further comprising a polarizing spectrometer to measure and control stress defects.

Embodiments 54: The device of any of Embodiments 38 to 53, further comprising an in-line optical analyzer to measure, characterize and quantify particle defects.

Embodiments 55: The device of any of Embodiments 38 to 54, wherein the device thermoforms the thermoplastic sheet by vacuum thermoforming with optional plug assist, drape forming, pressure forming, matched-mold pressing or membrane pressing with optionally hot or cold bladder hydraulics.

Embodiment 56: A method for stretching, thermoforming and heat setting a thermoplastic sheet, wherein the method comprises:
stretching the thermoplastic sheet utilizing grippers attached around the periphery of the thermoplastic sheet, wherein at least a portion of the grippers are mobile so as to be outwardly movable to stretch the thermoplastic sheet; thermoforming the thermoplastic sheet;
heat setting the thermoplastic sheet; and
heating the thermoplastic sheet during each of the stretching, thermoforming and heat setting steps.

Embodiment 57: The method of Embodiment 56, wherein at least a portion of the grippers are capable of being retracted to outwardly stretch the thermoplastic sheet.

Embodiment 58: The method of Embodiment 57, further comprising moving the grippers upward or downward over a mold during stretching wherein the mold is used the thermoforming step.

Embodiment 59: The method of any of Embodiments 56 to 58, further comprising spacing the grippers to avoid heat shielding and thus allowing the thermoplastic sheet portions between the grippers to be heated.

Embodiment 60: The method of any of Embodiments 56 to 59, wherein the stretching step and the thermoforming step occur sequentially or optionally simultaneously.

Embodiment 61: The method of any of Embodiments 56 to 60, wherein the stretching step is performed in only one direction.

Embodiment 62: The method of any of Embodiments 56 to 60, wherein the stretching step is performed in two orthogonal directions.

Embodiment 63: The method of Embodiment 62, wherein the stretching in the two orthogonal directions occur simultaneously.

Embodiment 64: The method of Embodiment 62, wherein the stretching in the two orthogonal directions occur in a sequential manner.

Embodiment 65: The method of any of Embodiments 56 to 64, wherein the grippers are capable of retracting or moving by different, graduated lengths independently.

Embodiment 66: The method of any of Embodiments 56 to 65, further comprising measuring and controlling the force applied to stretch the thermoplastic sheet independently at each gripper.

Embodiment 67: The method of any of Embodiments 56 to 66, further comprising correlating the measured force, normalized for sheet type and thickness, to calculate the degree of pre-stretching that may be present in the sheet prior to the step of stretching.

Embodiments 68: The method of any of Embodiments 56 to 67, wherein the grippers are configured to retract and move at different rates.

Embodiment 69: The method of any of Embodiments 56 to 68, further comprising measuring stress defects during the steps of stretching, thermoforming and/or heat setting.

Embodiment 70: The method of any of Embodiments 56 to 69, further comprising measuring particle defects during the steps of stretching, thermoforming and/or heat setting.

Embodiment 71: The method of Embodiment 70, further comprising classifying the measured particle defects as black specks, gels or contamination with histogram output for quality control improvement.

Embodiment 72: The method of any of Embodiments 56 to 71, wherein the thermoforming step includes vacuum thermoforming with optional plug assist, pressurized air, drape forming, pressure forming, matched-mold pressing or membrane pressing with optionally hot or cold bladder hydraulics.

Embodiment 73: The method of any of Embodiments 56 to 72, wherein the stretching step causes semi-crystalline thermoplastics to form small, mechanically-induced crystals thereby increasing the heat stability above the material's glass transition temperature.

Embodiment 74: The article according to any of Embodiments 3 to 33, wherein chemical composition of final formed article, in aggregate, passes the requirements which classify the article as polyethylene terephthalate according to the state of California in Assembly Bill 906, including Section 18013.

In this disclosure, the word “set point” has been used to signify a targeted range of specific conditions to properly process the substrate. For example, PET is often properly stretched at about 10 to 15 degrees Celsius above its glass transition temperature. The word “set point” therefore is used to designate the approximate target temperature at which this function should be performed. Using the same example, in one aspect “properly stretched” can refer to a stretch ratio of 1.75. The word “set point” can be used to designate the approximate range of sheet length and/or width extension to achieve a stretch ratio of 1.75. The word “set point” is used with other targeted conditions as well to facilitate targeted sheet properties.

Therefore, the present compositions and methods are well adapted to attain the ends and advantages mentioned, as well as those inherent therein. The particular examples disclosed above are illustrative only, as the present methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. Every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1-20. (canceled)

21. A process for producing a clear, three-dimensional article, said process comprising:
(a) providing a clear crystalline or semi-crystalline thermoplastic film or sheet having an average thickness of at least 0.010 inches but not more than 0.500 inches, wherein the film or sheet has a glass transition temperature and is provided as a heated film or sheet at a temperature above the glass transition temperature of the film or sheet and low enough to retain any crystallinity of the film or sheet;
(b) stretching the heated film or sheet between 1.2 to 7 times its original dimension; and
(c) forming the film or sheet into the three-dimensional article during or after the stretching process.

22. The process of claim 21, wherein the crystallinity of the film or sheet has a crystal size below 700 nanometers, and the providing in step (a) and stretching in step (b) are at a temperature above the glass transition of the film or sheet and low enough to retain the crystallinity such that the crystal size is below 700 nanometers after stretching.

23. The process of claim 21, wherein the stretching step causes the formation of mechanically-induced crystals having a crystal size of 400 nm or less to thereby increase the heat stability of the article above the glass transition temperature of the film or sheet.

24. The process of claim 23, wherein:
the clear crystalline or semi-crystalline thermoplastic film or sheet has an average thickness of at least 0.015 inches but not more than 0.190 inches;
in the step of stretching, the film or sheet is stretched between 1.5 to 3.5 times its original dimension; and
wherein the resulting three-dimensional article can withstand long-term exposure to steam sterilization between 115 and 170 degrees Celsius wherein the article, post steam sterilization, and maintains an average haze of less than 8% or alight transmission of greater than 75% when measured in 10 locations equidistant throughout the article.

25. The process of claim 24, further comprising heat-setting said article at a heat-setting temperature to produce a heat-set article, wherein the heat-set article can withstand long-term exposure to an elevated thermal climate that is at least equal to the glass transition temperature of the thermoplastic, up to the heat-setting temperature, which is below the melt temperature of the thermoplastic, wherein the article, post thermal climate exposure, exhibits less than 10% shrinkage and maintains an average haze of less than 8% (as measured by ASTM D1003) or a light transmission of greater than 75% (as measured by ASTM D1003) when measured in 10 locations equidistant throughout the article.

26. The process of claim 25, further comprising an ethylene oxide, gamma, steam, e-beam or chemically-activated sterilization process.

27. The process of claim 25, wherein the clear, three-dimensional article is heat set by placing or keeping the article on a mold, and subjecting said article to a temperature between the glass transition temperature and the melt temperature of the article for at least 5 seconds.

28. The process of claim 27, wherein the stretching in step (b) is performed in a bi-axial manner.

29. The process of claim 28, wherein the forming in step (c) utilizes a plug assist, pressurized air, matched mold, or hydraulic bladder to force the stretched sheet into or around the mold to form a proper shape.

30. A clear, three-dimensional article comprising a crystalline or semi-crystalline thermoplastic polymer with a crystallinity of at least 8% with a crystal size below 400 nanometers, haze less than 10% and light transmission greater than 70% that can withstand long-term exposure to elevated thermal climates that is at least equal to the glass transition temperature of the polymer but less than the melt temperature of the polymer.

31. The article of claim 30, wherein the elevated thermal climate is achieved via steam sterilization.

32. The clear, three-dimensional article of claim 30, made by a process comprising:
(a) providing a clear crystalline or semi-crystalline thermoplastic film or sheet having an average thickness of at least 0.010 inches but not more than 0.500 inches, wherein the film or sheet has a glass transition temperature and is provided as a heated film or sheet at a temperature above the glass transition temperature of the film or sheet and low enough to retain any crystallinity of the film or sheet;
(b) stretching the film or sheet between 1.2 to 7 times its original dimension so as to form mechanically-induced crystals having a crystal size of 400 nm or less to thereby increase the heat stability about the class transition temperature of the film or sheet; and
(c) forming a three-dimensional article during or after the stretching process.

33. The article of claim 30, wherein the clear, three-dimensional article has a measured haze value of less than 10% as measured by ASTM D1003 and a measured light transmission of greater than 70% as measured by ASTM D1003.

34. The article of claim 33, wherein the crystalline or semi-crystalline thermoplastic has a percentage of crystallinity from 8% to 30% as measured by DSC, SALLS or XRD.

35. The article of claim 34, wherein the clear, three-dimensional article has a birefringence or refractive index difference of greater than 0.005 when measured along the plane of the film or sheet in the stretched direction versus the non-stretched direction.

36. The article of claim 34, wherein the clear, three-dimensional article has a birefringence or refractive index difference of greater than 0.005 when measured along the plane of the film or sheet in the stretched direction versus the measurement taken through the film or sheet thickness direction.

37. The article of claim 30, wherein the clear, thermoplastic, crystalline or semi-crystalline film or sheet comprise aromatic or aliphatic versions of polyesters, polyamides, polyurethanes, polystyrene, polypropylene, cyclic olefin polymers and copolymers (COP/COC), polyarylates (PAR), Polycaprolactone (PCL), Polylactic acid (PLA), and copolymers, combinations and blends thereof.

38. The article of claim 37, wherein the film is crystalline or semi-crystalline polyester and the polyester can be either aromatic or aliphatic in nature and comprise, but are not limited to, polyethylene terephthalate (PET), amorphous polyethylene terephthalate (APET), glycol-modified polyethylene terephthalate (PETG), acid-modified polyethylene terephthalate (PETA), Polycyclohexylenedimethylene terephthalate (PCT), glycol-modified Polycyclohexylenedimethylene terephthalate (PCTG), acid-modified Polycyclohexylenedimethylene terephthalate (PCTA), polyethylene naphthalate (PEN), polyethylene furanoate (PEF), Polytrimethylene terephthalate (PTT), polybutylene terephthalate (PBT), Polybutylene Naphthalate (PBN), Polybutylene adipate-co-terephthalate (PBAT), Polytretramethylenecyclobutylene terephthalate (PCTM), Polycyclohexanedimethyl cyclohexanedicarboxylate (PCCD), Polycyclohexylene dimethylene cyclohexanedicarboxylate copolymer (PCCE, copolyester ether elastomer), Polycyclohexanedimethylene-co-isosorbide terephthalate, and copolymers, isomers and blends thereof.

39. The article of claim 38, wherein the primary monomers and secondary diol or diacid comonomers and additional comonomers, including multi-functional branching monomers, can be either aromatic or aliphatic in nature and comprise the following moieties: propylene glycol, 1,3-propanediol, 2,4-dimethyl-2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, 1,4-cyclohexanedimethanol, p-xylylene glycol, polyethylene glycol, diethylene glycol, polytetramethylene glycol, 2,2,4,4-tetramethyl-1,3-cyclobutanediol, phthalic acid, isophthalic acid, furandicarboxylic acid, 1,4-, 1,5-, 2,6-, and 2,7-naphthalenedicarboxylic acid, 1,3-, 1,4-cyclohexanedicarboxylic acid (which may be cis, trans or a mixture thereof), cyclohexanediacetic acid, trans-4,4′-stilbenedicarboxylic acid, 4,4′-oxydibenzoic acid, 3,3′- and 4,4′-biphenyldicarboxylic acids, malonic acid, succinic acid, glutaric acid, adipic acid, azelaic acid, sebacic acid, suberic acid, pimelic acid, nonane, decane, dodecanedicarboxylic acids. cyclohexane dimethanol, butanediol, propanediol, spiroglycol, isosorbide, 2,2,4,4-tetramethyl-1,3-cyclobutanediol, diethylene glycol, ethylene glycol, bisphenol A (BPA), pentaerythritol and polyethylene glycol (PEG), and combinations thereof.

40. The article of any of claim 30, wherein the clear, three-dimensional article is made from a hygroscopic polymeric material with a minimum moisture regain of at least 0.05%.
